(19) United States
(12) Patent Application Publication
(10) Pub. No.: US 2024/0221075 A1
(43) Pub. Date: Jul. 4, 2024

(54) System, Method and Article of Manufacture for Creating a Time and Data Minimized Securities Trade Recommendation

(71) Applicant: WEIR WEALTH MANAGEMENT, Cedarburg, WI (US)

(72) Inventors: Scott Weir, Cedarburg, WI (US); Alec Billingsly, Menomenee Falls, WI (US); Andrew Ellingham, Burlington, WI (US)

(21) Appl. No.: 18/088,706

(22) Filed: Dec. 26, 2022

(51) Int. Cl. G06Q 40/04; G06Q 40/06

(52) U.S. Cl. CPC G06Q 40/04; G06Q 40/06

(57) ABSTRACT

This Invention relates to a time and data efficient system method and article for creating a trade recommendation that obviates or minimizes the need for mining, storing and processing extensive quantities of economic and market research data, as well as employing extensive quantities of research personnel.

### CROSS REFERENCE TO RELATED APPLICATIONS

None

### TECHNICAL FIELD OF THE INVENTION

This invention relates generally to a system, method and article of manufacture for creating a trade recommendation relating to stocks, exchange traded funds (ETFs) or exchange traded notes (ETNs) traded over a stock exchange, such as the New York Stock Exchange (NYSE) or the National Association of Securities Dealers Automated Quotations Stock Market (NASDAQ). More specifically, this invention relates to a time and data efficient system, method and article for creating a trade recommendation that obviates or minimizes both the need for mining, storing and processing extensive quantities of economic and market research data, as well as the need for employing extensive quantities of research personnel in support thereof.

### BACKGROUND OF THE INVENTION

Financial advisors (FAs), investment advisors (IAs) and advisor's advisors (AAs) spend countless hours conducting research relating to stocks, bonds, annuities, commodities and packaged products (PPs), such as mutual funds, variable annuities sub accounts, exchange traded funds (ETFs), exchange traded notes (ETNs), closed end funds (CEFs), united investment trusts (UITs) etc., to facilitate the recommendation and creation of investment portfolios for their clients. Such research aids advisors in creating investment portfolios that have the preferred possibility of increasing in value over time, thus providing financial gains for the advisor's clients.

The advisor's research also supports the prediction of the future performance of existing portfolios, previously recommended and/or created by advisors, such that changes can be made to the portfolio to create or maintain its positive performance or expected performance objective. If the research indicates that a given portfolio will likely decrease in value, then those stocks, bonds, annuities, commodities and/or packaged products (PPs) predicted to decrease in value (i.e., perform poorly) are replaced by those predicted to increase in value (i.e., perform well). The foregoing research also assists advisors in deciding when to purchase or sell the underlying stocks, bonds, annuities, commodities and packaged products, either in replacing those that perform poorly, or in selecting new ones in the creation of new portfolios. In doing so, an advisor desires to purchase low and sell high, thus optimizing the portfolio's overall value.

The research underlying a financial and investment advisor's selection of the stocks, bonds, annuities, commodities and packaged products in recommending or creating a given investment portfolio is multi-faceted; typically including economic and socioeconomic research, market research, sector rotation, product selection and weight allocation, as wells as fundamental, technical and sentimental analysis. Economic research typically includes a determination of the present or future location within a given economic cycle, an analysis of the effects of Federal Reserve Board (Fed) decisions, a consideration of political influence on the economy, as well as accounting for employment, money supply and/or inflation factors, Market research typically Includes a determination of the presence of a bear (falling prices) or bull (rising prices) market within the stock market, a given volume within that market, as well as the actions of retail vs. institutional investors in relation to that market.

Sector rotation, which is generally the movement of money invested in the stock market from one Industry to another as traders and advisors anticipate the next stage of the market or economic cycle, such as moving stocks, bonds, commodities, packaged products (PPs) such as variable annuity sub accounts, mutual funds, exchange traded funds (ETFs), exchange traded note (ETNs), closed end funds (CEFs), unit investment trusts (UITs) and other securities in a client's portfolio from one industry to another, includes a time-determinative analysis of both economic and market cycles; a determination of which sectors perform best within those economic and market cycles, as well as any effect on those cycles by consumer variables, political topics, global trade and/or supply, geopolitical issues, etc. Product selection Includes; running a screener (making a given selection via user-defined metrics) based on stock, bond, commodities, packaged products (i.e., mutual funds, EFTs or ETNs CEFs UITs) and other securities requirements, to include drawdown (peak-to-trough decline over the given time of an investment), return, beta/alpha, and dividend yield considerations; selecting an individual stock or packaged product (i.e., mutual funds, ETFs, ETNs, CEFs and UITs) based upon fundamental and technical data; and determining the price targets for the purchase and/or sales of the stock or packaged product (i.e., mutual funds, ETFs, ETNs CEFs and UITs). Finally, weight allocation includes a determination of the percentages of those products or sectors that match a given client's risk tolerance.

The foregoing process, however, is fraught with inherent disadvantages. For example, market research and sector rotation analyses each utilize vast quantities of data and the associated processing thereof, which thus requires extensive computers systems and software to mine the underlying information from various sources over the Internet, extensive memory for such computers (either on-site or remotely-located) to store the vast quantities of underlying information mined, as well as potent processors capable of processing the mined Information to facilitate the needs of financial advisors. However, the foregoing computer systems are expensive, as well as the licensing from third parties of the underlying computers systems and services used in lieu of possessing them, thus resulting in a financial impediment to smaller financial service advisors.

For those advisory services not possessing the aforementioned extensive computer systems or licensing of the same, the market research and sector rotation data is nonetheless obtainable via the utilization of extended research personnel, either employed by the advisor, or utilized as third party providers thereto. However, the foregoing personnel and third party providers of these services are expensive, again resulting in a financial impediment to smaller financial service advisors. Also, third party research providers may have a bias towards providing research data for, or otherwise recommending, securities or packaged products that the provider “sponsors” or offers, thus greatly reducing the objectiveness of the research results and the advisor's ability to objectively work in the best interest of the client. Moreover, the utilization of personnel to “manually” mine and process the extensive research data is very time consuming, with the length of time required of the market research and sector rotation analysis often exceeding the duration of a change or fluctuation in the economic or market cycle, thus rendering the results of the research and analysis instantly obsolete.

Furthermore, the timing of the receipt and processing of the mined data is often imprecise due to the extended time frames over which such data is typically mined and processed (I.e., over a 6 month period or more). The extended time frames thus make the predictability of the underlying data uncertain in view of sudden and/or short term changes in the market. Even when utilizing the foregoing data over a short-term duration, the data itself is highly variable, again presenting difficulties in the data's accuracy and the related financial recommendations made in relation thereto.

Thus, what financial and investment advisors need are a system, method and article of manufacture that bypass the need for the mining and processing of the extensive date underlying market and economic research and sector rotation. The system, method and article should allow financial and investment advisors to make timely and sound investment recommendations without the need for costly extensive computer systems and associated extended memory and processing capabilities. These same investment recommendations should also forego the need for the costly extended research personnel requisite of mining and processing the data in lieu of complex computer systems. The system, method and article should also accommodate in providing both timely and accurate investment recommendations over the short term while compensating for data variability. The present invention satisfies the foregoing needs and provides other advantages over the prior art as well.

### SUMMARY OF THE INVENTION

A system for creating a securities recommendation preferably comprises a processor; a computer-readable memory, network interface, input device and output device coupled to the processor; Instructions stored on the computer-readable memory which, when executed by the processor, configures the processor to perform operations that Include; receiving, from the network interface or input device, a trading-time date range, a current at least one ticker corresponding with the trading-time date range, a bullish sentiment survey data percentage value and a bearish sentiment survey data percentage value, the sentiment survey data percentage values having a survey date range common with the trading-time date range, and at least one buffer percentage range; determining a current sentiment data percentage value by subtracting an absolute value of the bearish sentiment survey data percentage value from an absolute value of the bullish sentiment survey data percentage value; comparing the current sentiment data percentage value to the at least one buffer percentage range and determining whether the current sentiment data percentage value falls within the at least one buffer percentage range or outside the at least one buffer percentage range; and outputting the securities recommendation to the to the output device if the current sentiment data percentage value fails outside the at least one buffer percentage range, said securities recommendation comprising a recommendation to invest in the current at least one ticker.

The system optionally further comprises Instructions stored on the computer-readable memory which, when executed by the processor, configures the processor to perform operations that include: determining, if the current sentiment data percentage value falls within the at least one buffer percentage range, a first data drift tolerance value by subtracting from the current sentiment data percentage value a first prior sentiment data percentage value occurring at an earlier time by a first time duration; comparing the first data drift tolerance value to the at least one buffer percentage range and determining whether the first data drift tolerance value falls within the at least one buffer percentage range or outside the at least one buffer percentage range; and outputting the securities recommendation to the output device if the first data drift tolerance value falls outside the at least one buffer percentage range, said securities recommendation comprising a recommendation to invest in the current at least one ticker.

The system optionally further comprises Instructions stored on the computer-readable memory which, when executed by the processor, configures the processor to perform operations that include: determining, if the first data drift tolerance value falls within the at least one buffer percentage range, a second data drift tolerance value by subtracting from the current sentiment data percentage value a second prior sentiment data percentage value occurring at an earlier time by a second time duration; comparing the second data drift tolerance value to the at least one buffer percentage range and determining whether the second data drift tolerance value falls within the at least one buffer percentage range or outside the at least one buffer percentage range; and outputting the securities recommendation to the output device if the second data drift tolerance value falls outside the at least one buffer percentage range, said securities recommendation comprising a recommendation to invest in the current at least one ticker.

The system optionally further comprises instructions stored on the computer-readable memory which, when executed by the processor, configure the processor to perform operations that include: outputting the securities recommendation to the output device if the second data drift tolerance value falls within the at least one buffer percentage range, said securities recommendation comprising a recommendation to hold a prior at least one ticker received by the processor at a time earlier than the current at least one ticker.

For the system, the at least one ticker preferably comprises a pair of tickers comprising a bullish ticker and a bearish ticker. Also, the recommendation to invest in the current at least one ticker preferably comprises a recommendation to invest in the bullish ticker if the current sentiment data percentage value, the first data drift tolerance value or the second data drift tolerance value falls above the at least one buffer percentage range; and a recommendation to invest in the in the bearish ticker if the current sentiment data percentage value, the first data drift tolerance value or the second data drift tolerance value falls below the at least one buffer percentage range. Preferably, the survey date range comprises one week, the first time duration comprises one week, and the second time duration comprises three weeks.

A computer implemented method for creating a securities recommendation comprises the steps of: utilizing a computer processor coupled to a computer-readable memory, input device and output device, the memory having instructions stored thereon for execution by the processor; receiving, by the processor, a trading-time date range, a current at least one ticker corresponding with the trading-time date range, a bullish sentiment survey data percentage value and a bearish sentiment survey data percentage value, with the sentiment survey data percentage values having a survey date range common with the trading-time date range, and at least one buffer percentage range from the input device; determining, by the processor, a current sentiment data percentage value by subtracting an absolute value of the bearish sentiment survey data percentage value from the bullish sentiment survey data percentage value; comparing, by the processor, the current sentiment data percentage value to the at least one buffer percentage range and determining, by the processor, whether the sentiment raw difference percentage value falls within the at least one buffer percentage range or outside the at least one buffer percentage range; and outputting, by the processor to the output device, the securities recommendation if the sentiment data percentage value falls outside the at least one buffer percentage range, said securities recommendation comprising a recommendation to invest in the current at least one ticker.

The method optionally further comprises determining, by the processor, if the current at least current sentiment data percentage value falls within the at least one buffer percentage range, a first data drift tolerance value by subtracting from the current sentiment data percentage value a first prior sentiment data percentage value occurring at an earlier time by a first time duration; comparing, by the processor, the first data drift tolerance value to the at least one buffer percentage range and determining, by the processor, whether the first data drift tolerance value falls within the at least one buffer percentage range or outside the at least one buffer percentage range; and outputting, by the processor, the securities recommendation to the output device if the first data drift tolerance value falls outside the at least one buffer percentage range, said securities recommendation comprising a recommendation to invest in the current at least one ticker.

The method optionally further comprises determining, by the processor, if first data drift tolerance value falls within the at least one buffer percentage range, a second data drift tolerance value by subtracting from the current sentiment percentage difference value a second prior sentiment data percentage value occurring at an earlier time by a second time duration; comparing, by the processor, the second data drift tolerance value to the at least one buffer percentage range and determining, by the processor, whether the second data drift tolerance value falls within the at least one buffer percentage range or outside the at least one buffer percentage range; and outputting, by the processor, the securities recommendation to the output device if the second data drift tolerance value falls outside the at least one buffer percentage range, said securities recommendation comprising a recommendation to invest in the current at least one ticker.

The method optionally further comprises outputting, by the processor, the securities recommendation if the second data drift tolerance value falls within the at least one buffer percentage range, said securities recommendation comprising a recommendation to hold a prior at least one ticker received by the processor at a time earlier than the current at least one ticker.

For the method, the at least one ticker preferably comprises a pair of tickers having a bullish ticker and a bearish ticker. Also, the recommendation to invest in the current at least one ticker comprises a recommendation to invest in the bullish ticker if the current sentiment data percentage value, the first data drift tolerance value or the second data drift tolerance value falls above the at least one buffer percentage range, and a recommendation to invest in the bearish ticker if the current sentiment data percentage value, the first data drift tolerance value or the second data drift tolerance value falls below the at least one buffer percentage range. Preferably, the survey date range comprises one week, the first time duration comprises one week, and the second time duration comprises three weeks.

A computer software product includes a non-transitory computer readable storage medium readable by a processor, with the medium having stored there-on a set of instructions for creating a securities trade recommendation comprising: a first sequence of instructions which, when executed by the processor, causes the processor to receive a trading-time date range, a current at least one ticker corresponding with the trading-time date range, a bullish sentiment survey data percentage value and a bearish sentiment survey data percentage value, the survey data percentage values having a survey date range common with the trading-time date range, and at least one buffer percentage range through a network Interface or an input device; a second sequence of instructions which, when executed by the processor, causes the processor to determine a current sentiment data percentage value by subtracting an absolute value of the bearish sentiment survey data percentage value from an absolute value of the bullish sentiment survey data percentage value; a third sequence of instructions which, when executed by the processor, causes the processor to compare the current sentiment data percentage value to the at least one buffer percentage range and determine whether the current sentiment data percentage value falls within the at least one buffer percentage range or outside the at least one butter percentage range; and a fourth sequence of instructions which, when executed by the processor, causes the processor to output the securities recommendation to an output device if the current sentiment data percentage value falls outside the at least one buffer percentage range, said securities recommendation comprising a recommendation to Invest in the current at least one ticker.

The medium optionally further comprises a fifth sequence of instructions which, when executed by the processor, causes the processor to determine, it the current sentiment data percentage value falls within the at least one buffer percentage range, a first data drift tolerance value by subtracting from the current sentiment data percentage value a first prior sentiment data percentage value occurring at an earlier time by a first time duration; a sixth sequence of instructions which, when executed by the processor, causes the processor to compare the first data drift tolerance value to the at least one buffer percentage range and determine whether the first data drift tolerance value falls within the at least one buffer percentage range or outside the at least one buffer percentage range; and a seventh sequence of Instructions which, when executed by the processor, causes the processor to output the securities recommendation to the output device if the first data drift tolerance value falls outside the at least one buffer percentage range, said securities recommendation comprising a recommendation to invest in the current at least one ticker.

The medium optionally further comprises an eighth sequence of Instructions which, when executed by the processor, causes the processor to determine, it the first data drift tolerance value falls within the at least one buffer percentage range, a second data drift tolerance value by subtracting from the current sentiment data percentage value a second prior sentiment data percentage value occurring at an earlier time by a second time duration; a ninth sequence of instructions which, when executed by the processor, causes the processor to compare the second data drift tolerance value to the at least one buffer percentage range and determine whether the second data drift tolerance value falls within the at least one buffer percentage range or outside the at least one buffer percentage range; and a tenth sequence of Instructions which, when executed by the processor, causes the processor to output the securities recommendation to the output device if the second data drift tolerance value falls outside the at least one buffer percentage range, said securities recommendation comprising a recommendation to invest in the current at least one ticker.

The medium optionally further comprises an eleventh sequence of instructions which, when executed by the processor, causes the processor to output the securities recommendation to an output device if the second data drift tolerance value falls within the at least one buffer percentage range, said securities recommendation comprising a recommendation to hold a prior at least one ticker received by the processor at a time earlier than the current at least one ticker.

For the medium, the at least one ticker comprises a pair of tickers comprising a bullish ticker and a bearish ticker. Also, the recommendation to invest in the current at least one ticker comprises a recommendation to invest in the bullish ticker if the sentiment data percentage value, the first data drift tolerance value or the second data drift tolerance value falls above the at least one buffer percentage range, and a recommendation to invest in the bearish ticker if the sentiment data percentage value, the first data drift tolerance value or the second data drift tolerance value falls below the at least one buffer percentage range. Preferably, the survey date range comprises one week, the first time duration comprises one week, and the second time duration comprises three weeks.

### BRIEF DESCRIPTION OF THE DRAWINGS

FIG. 1 illustrates a flow chart depicting the exemplary components of a computer system underlying the present system, method and article of manufacture for creating a securities trade recommendation;

FIG. 2 illustrates a flow chart depicting data input, calculation, a first comparison and recommendations within an exemplary process underlying the present system, method and article of manufacture for creating the securities trade recommendation;

FIG. 3 illustrates a continuation of the flow chart of FIG. 2, and depicts data input, retrieval, calculation, a second comparison and recommendations within the same exemplary process;

FIG. 4 illustrates a continuation of the flow chart of FIG. 3, and depicts data input, retrieval, calculation, a third comparison and recommendations within the same exemplary process;

FIG. 5 illustrates a sequence diagram depicting the time relationship between the current sentiment data percentage and the first and second prior sentiment data percentages;

FIG. 6 illustrates a flow chart depicting the detailed components of one embodiment of the present system for the system for creating the trade securities trade recommendation;

FIG. 7 illustrates one embodiment of a graphical user Interface of the present system of FIG. 6;

FIG. 8 illustrates another embodiment of a graphical user interface of the present system of FIG. 6, said graphical interface Including an email execution component; and

FIG. 9 illustrates another embodiment of a graphical user interface of the present system of FIG. 8, said graphical interface including a time period reporting component.

### DETAILED DESCRIPTION

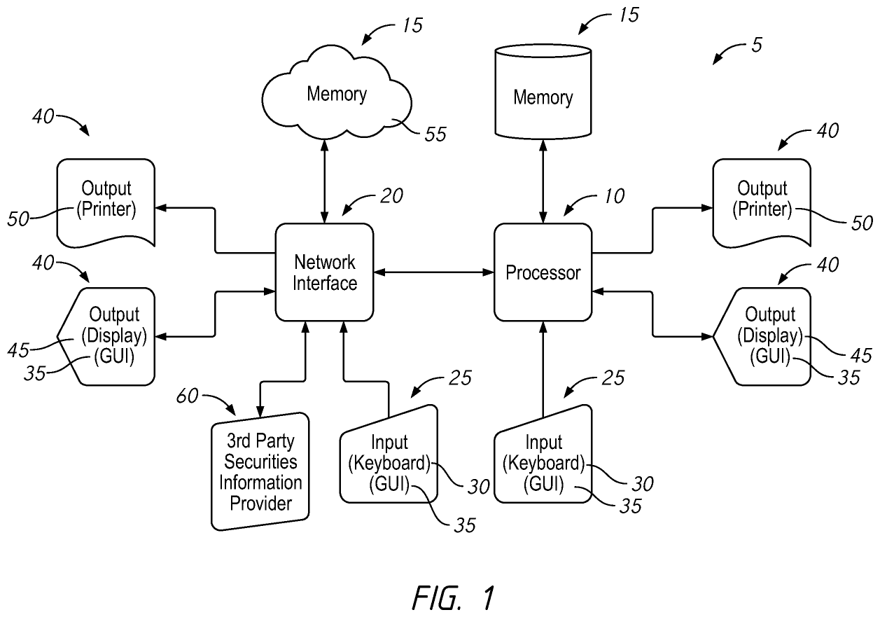

Referring to FIG. 1, a computer executed system, method and article of manufacture for creating a trade recommendation preferably utilizes a computer system 5 having one or more processors 10 coupled to a memory 15, a network Interface 20, one or more input devices 25 (comprising a keyboard 30 and/or graphical user interface “GUI” 35), and one or more output devices 40 (comprising a display 45, printer 50 and/or the GUI 35). The memory 15 (i.e., cloud memory 55), the one or more input devices 25, the one or more output devices 40 and/or one or more third party securities information providers 60 (to be further discussed) may be optionally coupled to the processor 10 through the network Interface 20.

Information and data are input or entered into the system 5 and received by the processor 10 via the one or more input devices 25 (i.e, keyboard 30 and/or GUI 35) and/or the one or more securities Information providers 60. Information and data received and created by the processor 10 may be stored in the memory 15, locally of the processor and/or remotely thereof through the network Interface 20 within the cloud memory 55. The memory 15 may comprise any suitable type of computer storage medium readable by the processor 10, which may include a magnetic recording apparatus, an optical disk, a magneto-optical disk, and/or a semiconductor memory, for example, random access memory (RAM), read only memory (ROM), and/or “thumb” drives, etc. Examples of the magnetic recording apparatus may include a hard disk device (HOD), a flexible disk (FD), and a magnetic tape (MT). Examples of the optical disk include a digital versatile disc (DVD), a digital versatile disc-random access memory (DVD-RAM), a compact disc (CD), to include compact disc-read only memory (CD-ROM), compact disc-recordable (CD-R) and compact disc-read/write (CD-RW). Data retrieval, analyses, calculations, compilations and/or comparisons creating the recommendations are performed by the processor 10, which may be any suitable type of computer processor, with the recommendations presented to the user through the one or more output devices 40 (i.e., display 45, printer 50 and/or GUI 35) and/or saved to the memory 15 (i.e., magnetic, semi, conductor or optical storage).

As understood in the art, the components of the system of FIG. 1 are in communication with one another by any suitable data bus, as is known in the art, and/or through the Internet, a wide area network (WAN), a local area network (LAN). WIFI and/or Bluetooth communication.

As further understood in the art, the foregoing components of the system 5 may be incorporated entirely or in part within any suitable type of computing device or programmable logic controller, including, but not limited to, personal computers, server computers, hand-held or laptop computers, mobile devices, such as “smart” mobile phones and personal digital assistants (PDAs), media players, tablets, and the like, multiprocessor systems, consumer electronics, mini computers, mainframe computers, as well as within distributed computing environments that include one or more of these system and/or foregoing components.

The foregoing components may thus be implemented as a system 5, method 6, or article of manufacture 7 to facilitate the use and operation of the claimed Invention. The term “article of manufacture,” as used herein, is intended to encompass a computer software product comprising one or more instructions stored on a non-transitory computer-readable storage medium, memory, or on other computer-readable media, devices or carriers, for instructing the processor 10 of the system 5. Of course, modifications may be made to these configurations without departing from the scope or spirit of the subject matter disclosed and claimed herein.

### Process

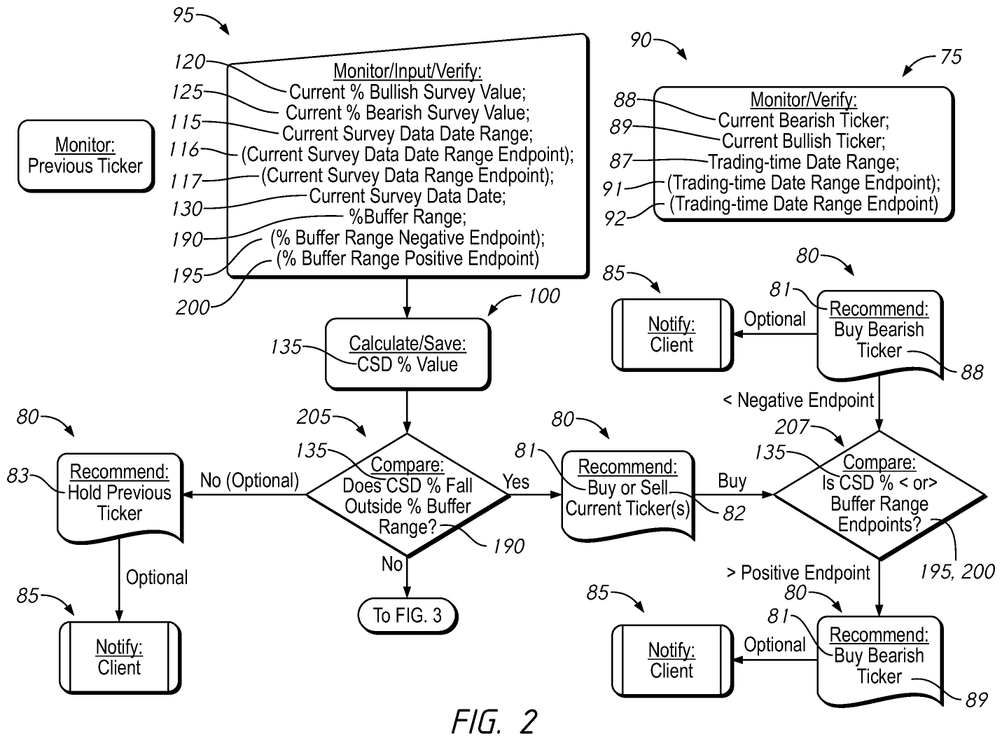

FIGS. 2-4 illustrate a flow chart of one embodiment of the overall process 75 underlying the time and data minimizing system 5, method 6 and article of manufacture 7, with the end result of the process comprising a recommendation 80 to buy 81 or sell 82 at least one current security, or to merely hold 83 a given at least one current security, and an optional automated and timely electronic notification 85 to a client of the recommendation. At least one stock ticker 86 is preferably utilized as the at least one security, with the at least one ticker and an associated ticker trading-time date range 87 preferably monitored and verified 90 by the user or system 5 for correlation with a sentiment survey data date range (to be further discussed).

A stock ticker is a report of the price of certain securities updated continuously throughout a given trading session by various stock market exchanges, with the ticker Information generally made available from a securities information provider, such as “Yahoo Finance” (www.finance.yahoo.com), “Barron's” (www.barons.com) or “Bloomberg Markets” (www.bloomberg.com). In a preferred embodiment, the at least one ticker 86 comprises a pair of stock tickers of respective bearish (i.e., performing well in a down market) and bullish (i.e. performing well in an up market) performance that are current (i.e. presently traded) in real time (i.e., a current bearish ticker 88 and a current bullish ticker 89). Although any security may be utilized for each ticker 88 and 89 of the pair, a preferred embodiment utilizes at least one negative-beta (i.e., bearish) and one high-beta (i.e. bullish) exchange traded fund (ETF) or note (ETN).

The negative and high beta values represent the risk of a given security, as compared to the Standard & Poor's 500 (S & P 500), which is a stock market index tracking the stock performance of 500 large companies listed on stock exchanges within the U.S. For example, the negative-beta ticker may utilize STAL, an exchange traded fund (ETF) holding securities (i.e., securities likely to perform well in a down market) and those shorting high-beta securities. The high-beta ticker, preferably using a value of above 1.0, and may utilize FNGS comprising an exchange traded note (ETN) holding bullish securities (i.e., securities likely to rise in value) such as AAPL (Apple, Inc.), AMZN (Amazon.com, Inc.), SABA (Alibaba Group Holding, Ltd.), BIDU (Baidu, Inc.). GOOG (Alphabet, Inc.), META (Meta Platforms. Inc.), NFLX (Netflix). NVDA (NVIDIA Corp.) and TSLA (Tesla, Inc.).

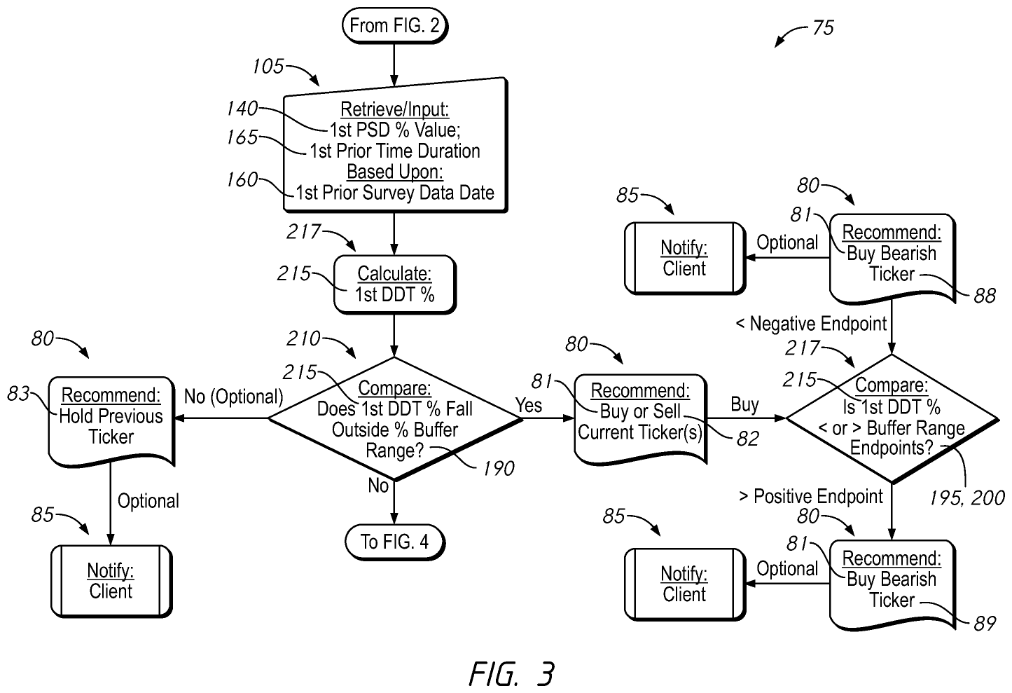

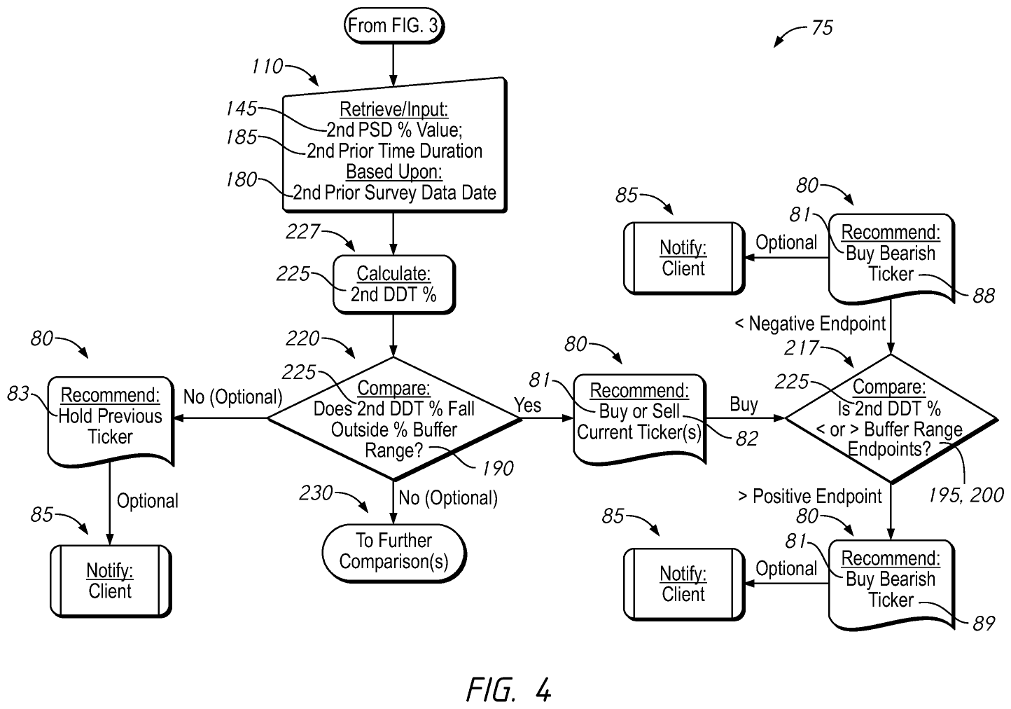

Referring again to FIGS. 2-4, in one embodiment, the process preferably begins with the monitoring, input and verification 95 (FIG. 2) of sentiment survey data values, a sentiment survey data date range and at least one buffer percentage range. From the sentiment survey values and sentiment survey data range, three sentiment percentage values are derived, namely, a current sentiment data (CSD) percentage value, which is preferably calculated and saved 100 (FIG. 2), a first prior sentiment data (1^{st} PSD) percentage value, which is optionally and conditionally retrieved and input 105 (FIG. 3), and second prior sentiment data (2^{nd} PSD), which is also optionally and conditionally retrieved and input 110 (FIG. 4). More specifically, the sentiment survey data values, from which the percentage values (CSD %), (1^{st} PSD %) and (2^{nd} PSD %) are derived, originate from yet another third party securities information provider 60, preferably The American Association of Individual Investors (the AAII). The AAII provides investor sentiment survey data that offers insight into individual investor's thoughts on the stock markers performance over a future six-month period. The measure is a popular tool in the investment world, as demonstrated by its utilization by at least the aforementioned Barron's and Bloomberg securities information providers. The specific question asked of survey members is: “do you feel the direction of the stock market over the next six months will perform well in an up market (be bullish), incur no change (be neutral), or perform well in a down market (be bearish)?”

The survey is conducted weekly, namely, from every Thursday at 12:01 am to every Wednesday at 11:59 pm, to define the aforementioned sentiment survey data date range culminating on the final day of the duration. i.e., on the sentiment data date, on which a Bullish-Neutral-Bearish sentiment percentile forecast of the market is reported. Because the sentiment survey is conducted weekly between the aforementioned Thursday and Wednesday dates, with the sentiment survey data utilized within the present process to provide the recommendation 80 relating to the at least one ticker 86, the ticker trading-time date range 87 preferably corresponds with the sentiment survey data date range to have a weekly duration defined by common start and end dates.

Referring again to the monitoring, input and verification 95 portion of the flowchart illustrated in FIG. 2, the results of the survey data reported by AAI on a given sentiment survey data date comprise “% Bullish,” “% Neutral” and “% Bearish” values, with the user or the system 5 preferably also monitoring at least the % Bearish and % Bullish of these values for the given week over real time leading up to that date. Survey data is considered “current” as created over a current survey data date range 115 (i.e., over a current week) in real time defined by beginning and ending endpoint values 116 and 117, both culminating and being reported by AAII on a current sentiment survey data date 130 (i.e., on a current Wednesday report date occurring at the end of the current week). Similarly, survey data is considered “prior” as created over a prior survey data range (i.e., a prior week), both culminating and being reported by AAII on a prior sentiment data date (i.e., on a prior Wednesday report date occurring at the end of the prior week). As will be further discussed, two such prior survey data date ranges with associated data dates are preferably utilized herein, namely a first prior survey data date range 156 with associated first prior survey data date 160, and a second prior data range 176 with associated second prior survey data date 180.

Thus, for the current survey data date range 115 culminating in the reported current % Bearish and % Bullish survey values 120 and 125 on the current survey data date 130, the current sentiment data (CSD) percentage value 135 is calculated 100 (FIG. 2) as the difference between an absolute value of the current % Bullish value and the absolute value of the current % Bearish value:

$$CSD \% = abs ( current \% Bullish survey value ) - abs ( current \% Bearish survey value ) .$$

The current sentiment data (CSD) percentage value is preferably saved 100 for the subsequent optional and conditional retrieval and input 105, 110 as the first and second prior sentiment data (1^{st} PSD and 2^{nd} PSD) percentage values 140 and 145, respectively (to be further discussed). Such retrieval is possible because the calculations underlying the CSD, 1^{st} PSD and 2^{nd} PSD values 135, 140 and 145 are Identical; with the data underlying the calculations being specific to their respective survey data date values 130, 160 and 180.

More specifically, the first prior sentiment data (1^{st} PSD) percentage value 140 comprises the same calculation 100 utilized in determining the current sentiment data (CSD) value 135, but applied to the % Bearish and % Bullish values reported by ASCII on the first prior survey data date (i.e., defining a first prior % Bearish value 150, a first prior % Bullish value 155 and a first prior survey data date value 160) by a first prior time duration 165 occurring prior to and from the current survey data date 160. Thus the first prior sentiment data (1^{st} PSD) percentage value 140 is calculated as the difference between an absolute value of the first prior % Bullish survey value 155 and the absolute value of the first prior % Bearish value 150:

1^{st} PSD%=abs (1^{st} prior % Bullish survey value)−abs(1^{st} prior % Bearish survey value).

Similarly, for a second prior time period, the second prior sentiment data (2^{nd} PSD) percentage value 145 comprises the same determination applied to % Bullish and % Bearish survey values provided by ASCII on a second prior survey data date (i.e., defining a second prior % Bearish survey value 170, a second prior % Bullish survey value 175 and a second prior survey data date value 120) that occurs in time by a second prior time duration 185 occurring prior to and from the current survey data date 160. Thus the second prior sentiment data (2^{nd} PSD) percentage value 145 is calculated as the difference between an absolute value of the second prior % Bullish survey value 170 and the absolute value of the second prior % Bearish survey value 175:

$${2}^{nd} PSD \% = abs ( {2}^{nd} prior \% Bullish survey value ) - abs ( {2}^{nd} prior \% Bearish survey value ) .$$

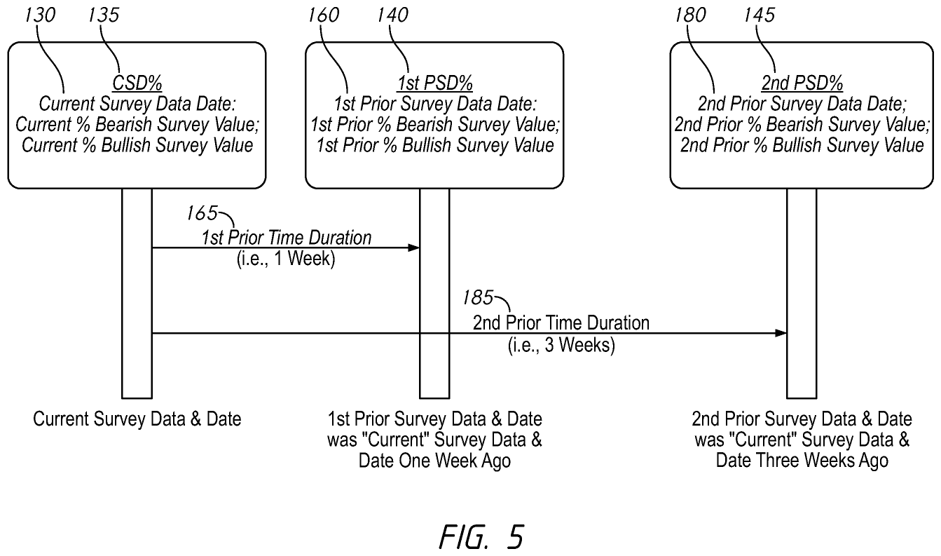

As depicted within the sequence diagram illustrated in FIG. 5, the first and second prior sentiment data (1^{st} PSD and 2^{nd} PSD) percentage values 140 and 145 were each thus previously “current” sentiment data percentage values when the associated respective first and second prior data date values 160 and 180 were “current” in real time. Upon the calculation of a given current sentiment data (CSD) percentage value 135 for a given current survey data date value 130, that percentage value is preferably saved 100 to memory and correlated with the associated date value such that it may be later retrieved (i.e., after a progression in real time of the an occurrence of the first and second “prior” time durations 165 and 185) by that prior first or second survey data date value and/or by that respective first or second “prior” time duration to establish the respective first and second prior sentiment data percentage values 140 and 145 without having to re-calculate them. Thus, when utilized with a given time duration defined in increments of weeks from the current survey data date value 130, the “prior” sentiment data (PSD) percentage value may be readily recalled from the memory 15 by the processor 10 as the first prior sentiment data (1^{st} PSD) and second prior sentiment data (2^{st} PSD) percentage values 140 and 145, according to the given time duration, when needed for further data analyses,

The respective first and second prior time durations 165 and 185, each preferably input to the system (FIGS. 3 and 4, respectively) may thus be summarily described as those durations separating a given current sentiment data date value 130 from the respective first and second prior sentiment data date values 160 and 180, thereby creating respective “data drifts” between the data derived on those dates. Thus, in a preferred embodiment, the first prior time duration 165 occurring between the current and first prior data date values 130 and 160 comprises one week (i.e., a one week data drift) while the second prior time duration 185 occurring between the current and second prior data date values 130 and 180 comprises three weeks (i.e., a three week data drift).

The one week data drift preferably captures short-term shifts in investor market confidence, such as when sudden or unexpected market or economic events quickly shift investor outlook in the market. Examples of such events include the Fed announcing drastic hikes or drops in interest rates, changes in employment, and the effects of COVID on the economy. However, it is understood that the first prior time duration 165 may comprise any duration of time longer or shorter than a week. The three week data drift captures longer-term shifts in investor market confidence and to smooth out any Irrelevant fluctuations of the returns. Examples of such fluctuations include updates to market data releases, loss of momentum in market movements, markets whipsawing between expected data and/or earnings results and actual results, as well as those fluctuations that may occur within the aforementioned one-week periods. However, it is understood that the second prior time duration 185 may comprise any duration of time longer or shorter than three weeks, so long as the second prior time duration exceeds the first prior time duration 165.

The at least one buffer percentage range 190, introduced within the monitor/input/verify 95 flow-chart portion illustrated within FIG. 2, preferably ensures an accurate correlation of the recommendations 80 to historic S & P 500 returns, with the at least one buffer percentage range, defined by negative and positive equivalent endpoint percentages 195 and 200 about a zero percentage value comprising any respective numerical value from 1% to 100%. Thus the at least one buffer percentage range 190, defined by the equivalent negative and positive endpoint percentages 195 and 200, may comprise: −1% to +1%; −2% to +2%; or any other negative and positive equivalents up to and including −100% to +100%. However, in a preferred embodiment, the at least one buffer percentage range 190 comprises—100% to 100%, more preferably −70% to 70%, and optimally −50% to 50%.

The foregoing at least one buffer range 190 and associated endpoints 195 and 200 are utilized as a basis for comparison in one or more percentage data comparisons that underlie the recommendations 80, with a first 205 (FIG. 2) of the one or more comparisons comprising a comparison of the current sentiment data (CSD) percentage value 135 to the at least one percentage buffer range 190. In a preferred embodiment, the first comparison 205 is optionally and conditionally followed a second comparison 210 (FIG. 3) comprising the comparison of a first data drift tolerance (1^{st} DDT) percentage value 215 to the at least one percentage buffer range 190, with the second comparison optionally and conditionally followed by a third comparison 220 of a second data drift tolerance (2^{nd} DDT) percentage value 225 to the at least one percentage buffer range.

Each comparison 205, 210 and 220 respectively determines whether or not the current sentiment data (CSD) percentage value 135, the first data drift tolerance (1^{st} DDT) percentage value 215 and the second data drift tolerance (2^{nd} DDT) percentage value 225 fall outside of, or within the at least one buffer percentage range 190 defined by the negative and positive endpoints 195 and 200. Although two comparisons 210 and 220 beyond the first 205 of the one or more comparisons are described and illustrated herein, it is nonetheless understood that any number of further comparisons 230 (FIG. 3) beyond the first comparison may be utilized for further data analyses.

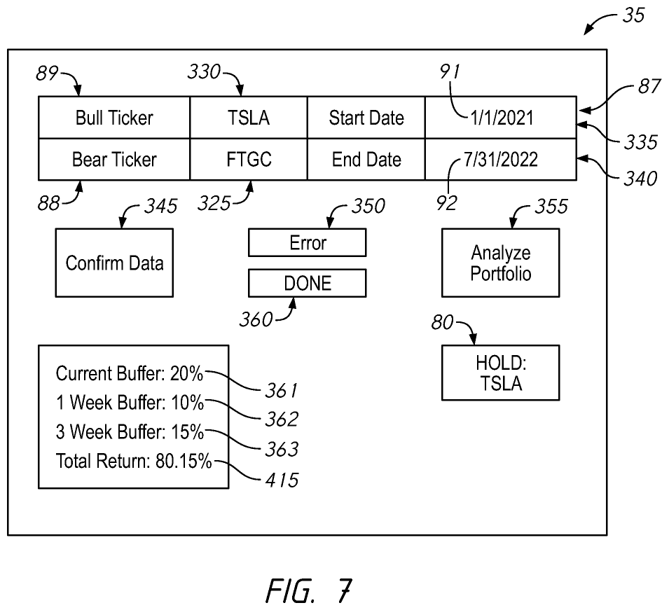

Referring again to FIGS. 2-4, it is noted that each subsequent percentage data comparison, namely, the second and third comparisons 210 and 220, preferably follow only if a given condition fails to occur as a result of the previous comparison, namely, when the current sentiment data (CS) percentage value 135 or first data drift tolerance (1^{st} DDT) percentage value 215 fails to fall within the at least one percentage buffer range 190. Moreover, each of the second and third comparisons 210 and 220 are denoted as “optional” because the advisor may optionally recommend 80 that the previous ticker be held 83 as a result of the condition failing to occur, instead of executing that respective further comparison. However, because each of the second and third comparisons 210 and 220 result in an increasingly accurate recommendation 80 to the client, the advisor allows for the execution of at least both of the second and third comparisons in a preferred embodiment of the invention, with the processor executing the first, second and/or third comparisons iteratively through various buffer ranges of the at least one buffer percentage range 190 to determine the optimum return recommendations 80 for the current 130, 1^{st} prior 156 and 2^{nd} prior 176 data date ranges. The processor 10 displays the return percentages for each date range value within the respective return indicators 361, 362 and 363 of FIG. 7, along with the “Total Return” percentage value 415 (i.e., the total net return percentage value) calculated by the processor.

First Comparison Referring again to FIG. 2, within the first comparison 205, the current sentiment data (CSD) percentage value 135 is compared to the at least one percentage buffer range 190. If the current sentiment data percentage (CSD) value 135 falls outside of the at least one percentage buffer range 190, then a recommendation 80 to buy 81 or sell 82 the at least one ticker 86 is presented to the user. For any recommendation 80 to buy 81 the at least one ticker 86, a further comparison is made of the current sentiment data (CSD) percentage value 135 to the at least one buffer range 190 comprising a supplemental comparison 207 of that value to the negative and positive endpoints 195 and 200 defining the range. Within the supplemental comparison 207. If the current sentiment date (CSD) percentage value 135 falls below (i.e., is less than) the negative endpoint 195 of the range 190, then a recommendation 80 is made to buy 81 the current bearish ticker 88. If the current sentiment data (CSD) percentage value 135 falls above (i.e., Is greater than) the positive endpoint 195 of the range 190, then a recommendation 80 is made to buy 81 the current bullish ticker 89.

However, if the current sentiment data (CSD) percentage value 135 falls within the at least one percentage buffer range 190 or on one of the positive or negative endpoints 195 or 200 of the range (i.e., the condition that it falls outside the at least one percentage buffer range fails to occur), then the system preferably proceeds to the second comparison 210. Optionally, however, if the current sentiment data (CSD) percentage value 135 falls within the at least one percentage buffer range 190 or on one of the positive or negative endpoints 195 or 200 of the range), then a recommendation 80 to hold 84 the previous ticker is presented to the user.

Within the second comparison 210 (FIG. 3), the first data drift tolerance (1^{st} DDT) percentage value 215 is compared to the at least one percentage buffer range 190, with the 1^{st} DDT percentage value previously calculated 217 (FIG. 3) as the difference between the current sentiment data (CSD) percentage value 135 and the first prior sentiment data (1^{st} PSD) percentage value 140:

$$1 st DDT \% = CSD \% - {1}^{st} PSD \%$$

If the first data drift tolerance (1^{st} DDT) percentage value 215 falls outside the at least one percentage buffer range 190, then the recommendation 80 to buy 81 or sell 82 the at least one ticker 86 is again presented to the user. For any recommendation 80 to buy 81 the at least one ticker 86, a further comparison is made of the first data drift tolerance (1^{st} DDT) percentage value 215 to the at least one buffer range 190 comprising a supplemental comparison 219 of that value to the negative and positive endpoints 195 and 299 defining the range. Within the supplemental comparison 219, if the first data drift tolerance (1^{st} DDT) percentage value 215 falls below (i.e., is less than) the negative endpoint 195 of the range 190, then a recommendation 80 is made to buy 81 the current bearish ticker 88. If the first data drift tolerance (1^{st} DDT) percentage value 230 falls above (i.e., is greater than) the positive endpoint 195 of the range 190, then a recommendation 80 is made to buy 81 the current bullish ticker 89.

However, if the first data drift tolerance (1^{st} DDT) percentage value 215 falls within the at least one percentage buffer range 190 or on one of the positive or negative endpoints 195 or 200 of the range (i.e., the condition that it falls outside the at least one percentage buffer range fails to occur), then the system preferably proceeds to the third comparison 220. Optionally, however, if the first data drift tolerance (1^{st} DDT) percentage value 215 falls within the at least one percentage buffer range 190 or on one of the positive or negative endpoints 195 or 200 of the range), then a recommendation 80 to hold 84 the previous ticker is presented to the user.

### Third Comparison

Within the third comparison 220 (FIG. 4), the second data drift tolerance (2^{nd} DDT) percentage value 225 is compared to the at least one percentage buffer range 190, with the second data drift tolerance (2^{nd} DDT) percentage value previously calculated 227 as the difference between the current sentiment data (CSD) percentage value 135 and the second prior sentiment data (2^{nd} PSD) percentage value 145:

$${2}^{nd} DDT \% = CSD \% minus {2}^{nd} PSD \% .$$

If the second data drift tolerance (2^{nd} DDT) percentage value 225 falls outside the at least one percentage buffer range 190, then the recommendation 80 to buy 81 or sell 82 the at least one ticker 86 is again presented to the user. For any recommendation 80 to buy 81 the at least one ticker 86, a further comparison is made of the second data drift tolerance (2^{nd} DDT) percentage value 225 to the at least one buffer range 190 comprising a supplemental comparison 229 of that value to the negative and positive endpoints 195 and 200 defining the range. Within the supplemental comparison 229, if the second data drift tolerance (2^{nd} DT) percentage value 225 falls below (i.e., is less than) the negative endpoint 195 of the range 190, then a recommendation 80 is made to buy 81 the current bearish ticker 88, if the second data drift tolerance (2^{nd} DDT) percentage value 225 falls above (i.e., is greater than) the positive endpoint 195 of the range 190, then a recommendation 80 is made to buy 81 the current bullish ticker 89. However, if the second data drift tolerance (2^{nd} DDT) percentage value 225 falls within the at least one percentage buffer range 190 or on one of the negative or positive endpoints 195 or 200 of the range (i.e., the condition that it falls outside the at least one percentage buffer range fails to occur), then a recommendation 80 to hold 84 a previous ticker is presented to the user.

As illustrated in FIGS. 2-4, the calculations 230 and 235 of the respective first and second data drift tolerance (1^{st} DDT and 2^{nd} DDT) percentage values 215 and 225, as well as the retrievals and inputs 105 and 110 of the respective first and second prior sentiment data (1^{st} PSD and 2^{nd} PSD) percentage values 140 and 145 underlying the calculations, are utilized only if the conditional requirements of the respective previous first and second comparisons 205 and 210 are not satisfied. For example, unless the current sentiment data (CSD) percentage value 135 fails to fall outside the at least one buffer range 190 within the first comparison 205 (FIG. 2), the need for the system 5 to calculate 230,235 the first and second data drift tolerances, retrieve/input 105, 110 the respective first and second prior sentiment data (1^{st} PSD and 2^{nd} PSD) percentage values 140 and 145 underlying the calculations, as well as execute the second and third data comparisons 205 and 219, are entirely bypassed, thus making the system more efficient,

Nonetheless, if the foregoing calculations 230, 235, data retrievals/inputs 105, 115, and data comparisons 210, 220 are indeed utilized, the resultant recommendations 80 are “accurized” and thus provide numerous and critical advantages over prior art processes utilizing sentiment data in its raw form. This is because, in its raw form, sentiment data utilize vast quantities of data obtained from numerous data sources (i e., see U.S. Patent Reg. No. 11,238,535), which thus possess inherent fluctuations in the sentiment data to render it unpredictable, at best. Furthermore, the vast quantity of sentiment data, in Its raw form, requires the aforementioned undesirable extensive computer systems and/or research personnel, and undesirable associated costs, to interpret and correlate these data for use as a securities recommendation tool. Obtaining the sentiment survey values 120 and 125 from the third party securities information provider allows the user to forego these undesirable costs.

However, the use of sentiment survey data results, which are accurized as disclosed and claimed in the present process, method and article, allows advisors to avoid such prohibitive costs. Also, because time is of the essence for financial advisors providing accurate trade recommendations to clients, the present invention also optionally timely notifies 85 clients, as illustrated in FIGS. 2-4, upon the recommendation 80 to buy 81, sell 82 or hold 83 a given ticker. This is preferably accomplished via an email or text notification sent from the system 5 to the computer and/or smart-phone of one or more clients of the user.

### System

### Input Stock Tickers and Date Range

FIG. 5 illustrates a flow chart of one embodiment of the steps comprising the execution of the process 75 of FIGS. 2-4 with a computer system 5, while FIG. 7 illustrates one embodiment of a graphical user interface (GUI) 35 of the system 5 for inputting data, executing commands and viewing output. More specifically and referring to FIGS. 5 and 7, securities information provided by the securities information provider 60, is monitored by the user, or by the system 5 through the network interface 20. Utilizing this information, the at least one stock ticker 861 input into the system 5. In a preferred embodiment, the at least one ticker 86 comprises a pair of stock tickers of respective bearish (i.e., performing well in a down market) and bullish (i.e. performing well in an up market) performance that are current (i.e., presently traded) in real time (i.e., a current bearish ticker 88 and a current bullish ticker 89) such that the pair is selected and input into the computer processor 10.

In one embodiment, the tickers 88 and 89 of the pair are selected by the user and input Into the processor 10 using the keyboard 30 and/or GUI 35 input devices. For example, as Illustrated in FIG. 7, the ticker values 88 and 89 (i.e., “BTAL” and “FNGS”) of the pair are manually entered into the ticker holding places 325 and 330 of the GUI 35. In another embodiment, the ticker values 88 and 89 are automatically selected by the processor 10 via information received through the network Interface 20 from the aforementioned securities Information provider 60, based upon selection parameters previously defined by the user. Although negative (bearish) and high (bullish) beta stock tickers 88 and 89 are preferably utilized, it is understood that the tickers may comprise any tradable investment security, to include bonds, commodities, and/or ETF's, ETN's and mutual funds comprising one or more of these security types.

Referring again to FIGS. 5 and 7, the trading-time date range 87, defined by trading-time beginning and ending endpoints (i.e., start and end dates “1/1/2021” and “7/31/2022”) 91 and 92, are also input to the processor 10 through the keyboard 30 and/or date range holding places 335 and 340 of the GUI 35. The trading-time beginning and ending endpoints 91 and 92 preferably comprise a start date falling on a Thursday and an end date falling on a subsequent Wednesday, preferably at the close of the market, to define a one-week duration. The one-week time duration of the trading-time date range 87 is preferred because it conforms to aforementioned one-week duration of the sentiment survey data date range 115.

It is understood, however, that any time duration of the trading-time date range 87 may be defined by the entered beginning and ending endpoints (i.e. start and end dates) 91 and 92, to include durations exceeding, or shorter than, a week. Although the date range values 91 and 92 of the trading-time date range 87 are input to the processor 10 via the keyboard 30 and/or into the holding places 335 and 340 of GUI 35 (FIG. 4), other embodiments of the system 5 and method utilize date values that are automatically selected and received by the processor 10 via information received through the network Interface 20, based upon calendar parameters previously defined by the user.

### Confirm Input Tickers and Date Range

Upon an input and/or selection of the ticker pair 88 and 89 and trading-time date range endpoint values 91 and 92, respectively, the user inputs a “confirm data” command to the processor 10 by using the keyboard 30 or by clicking on the “Confirm Data” button 345 within the GUI 35 (FIG. 7). The processor 10 thereafter verifies the credibility and trading time of the entered ticker values 88 and 89 using securities information received through the network Interface 20 from the securities information provider 60, in verifying the ticker values 88 and 89, the processor 10 confirms that the tickers underlying the negative (bearish) and positive (bullish) beta values are indeed actively trading, and that the trading-time duration for each of the tickers occurs for the trading-time date range 87 defined by the trading-time endpoint values (i.e., start and end dates)91 and 92.

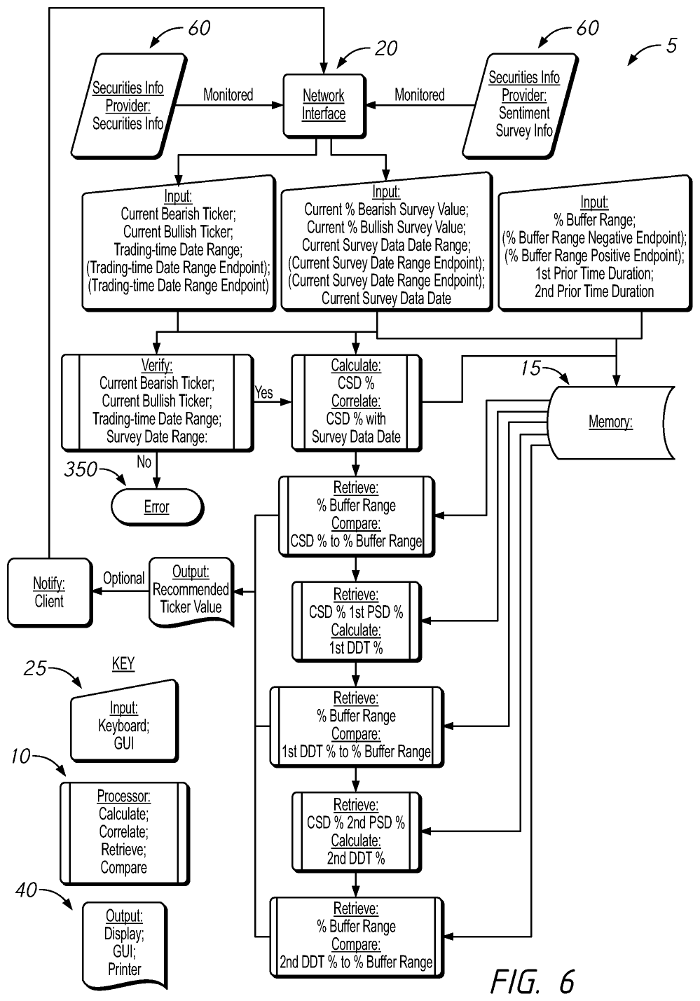

As illustrated in FIGS. 6 and 7, if the tickers are not actively trading (i.e., are “de-listed” from a given market), and/or not trading for the duration defined by the trading-time date range endpoint values 91 and 92, then the processor generates an error message for indication by output device 40 (i.e., by the printer 50, display 45 and/or the GUI 35) or by the GUI 35 input device 25. If indicated by the GUI 35 input device 10, the GUI highlights or indicates an “Error” message 350 (FIG. 7). The user thereafter adjusts the values within the ticker and date range holding places 325 and 330, 335 and 340, and again clicks on the Confirm Data button 345. If the tickers 88 and 89 are actively trading, and for the duration defined by the trading-time date range 87 endpoint values 91 and 92, then the Error message 345 within the GUI is de-highlighted or disappears and the processor 10 is allowed to proceed to the first comparison 205. To proceed to the first comparison 205 the user preferably inputs an “analyze data” command to the processor 10 by using the keyboard 30 or by clicking on the “Analyze Portfolio” button 355 within the GUI 35 (FIG. 7).

Referring again to FIG. 6, in support of the first comparison 204, the computer processor receives the pair of current sentiment survey data percentage values 120 and 125 provided by the third party securities Information provider 60; preferably The American Association of Individual Investors (the AAII). These values 120 and 125, again preferably comprising the current % Bearish value and current % Bullish value survey results for the current survey data range 115 (i.e., week) ending on the data range endpoint 92, denoted by the current survey data date value 130, are preferably monitored by the user or through the network interface 20 by the processor 10. The current % Bearish and Bullish survey values 120 and 125, and the current sentiment survey data date value 130, are received by the processor 10 via an input by the user through the input device 25 comprising the keyboard 30 and/or GUI 35, or through the network interface 20 directly from the securities information provider 60.

Having received the foregoing current % Bearish and % Bullish survey values 120 and 125, and current survey data date value 130, the processor 10 determines the current sentiment data (CSD) percentage value 135 by calculating difference between the absolute values of the respective % Bullish and % Bearish survey values 125 and 120:

CSD%=abs (current % Bullish survey value)−abs (current % Bearish survey value).

The processor 10 preferably saves the current sentiment data (CSD) percentage value 135 to the memory 15, preferably for later retrieval by the processor during the comparison processes 205, 210 and/or 220, Referring again to FIG. 5, when the current sentiment data (CSD) percentage value 135 is saved by the processor 10 into the memory 15, the processor correlates that value with the current sentiment data date value 130 such that, with the progression of real time, the “current” sentiment data (CSD) percentage value and associated “current” survey data date value become a respective “prior” sentiment data (PSD) percentage value and associated “prior” data date value, with the percentage value thus searchable within the memory by the processor by the data date value. Thus, when utilized with a given time duration defined in increments of weeks from the current survey data date value 130, the “prior sentiment data (PSD) percentage value may be readily recalled from the memory 15 by the processor 10 as the first prior sentiment data (1^{st} PSD) and second prior sentiment data (2^{nd} PSD) percentage values 140 and 145, according to the given time duration, when needed for further data analyses.

### First Comparison

To ensure an accurate correlation with historic S & P 500 returns, the at least one buffer percentage range 190 is input into the processor 10 through the keyboard 30 or GUI 35, with the at least one buffer percentage range comprising the aforementioned negative and positive equivalent endpoints 195 and 200 about the zero value. After the at least one buffer percentage range 190 is input into the processor 10, the processor compares the current sentiment data (CSD) percentage value 135 to the at least one buffer percentage range to determine whether or not the current sentiment data (CSD) percentage value falls outside of, or within the negative and positive endpoints 195 and 200 of the at the least one buffer percentage range. It the current sentiment data (CSD) percentage value 135 falls outside the negative and positive endpoints 195 and 200 of the at least one buffer percentage range 190, the processor 10 generates output to the output device (printer 50, display 45 and/or GUI 35) comprising the recommendation 80 recommending the current bearish or bullish ticker 88 or 89 of the pair to invest in.

Thus, with the current sentiment data (CSD) percentage value 135 falling outside the positive and negative endpoints 195 and 200 of the at least one buffer percentage range 190, the recommendation 80 will comprise a recommendation to buy (i.e., invest in) the current bearish ticker 88 if the current sentiment data (CSD) percentage value falls below (i.e., is less than) the negative endpoint of the buffer percentage range. Similarly, the recommendation 80 will comprise a recommendation to buy the current bullish ticker 89 if the current sentiment data (CSD) percentage value 135 falls above (i.e., is greater than) the positive endpoint 200 of the buffer percentage range 190. However, if the current sentiment data (CSD) percentage value 135 falls within the at least one percentage buffer range 190 or on one of its endpoints 195 or 200, the processor 10 preferably executes a command to proceed to the second comparison 210. In an alternate embodiment, the processor 10, without proceeding to the second comparison 210 for additional data analyses, generates output to the output device 40 (printer 50, display 45 and/or GUI 35) in the form of the recommendation 80 comprising a recommendation to “hold” 83 the ticker instead of buying or selling it.

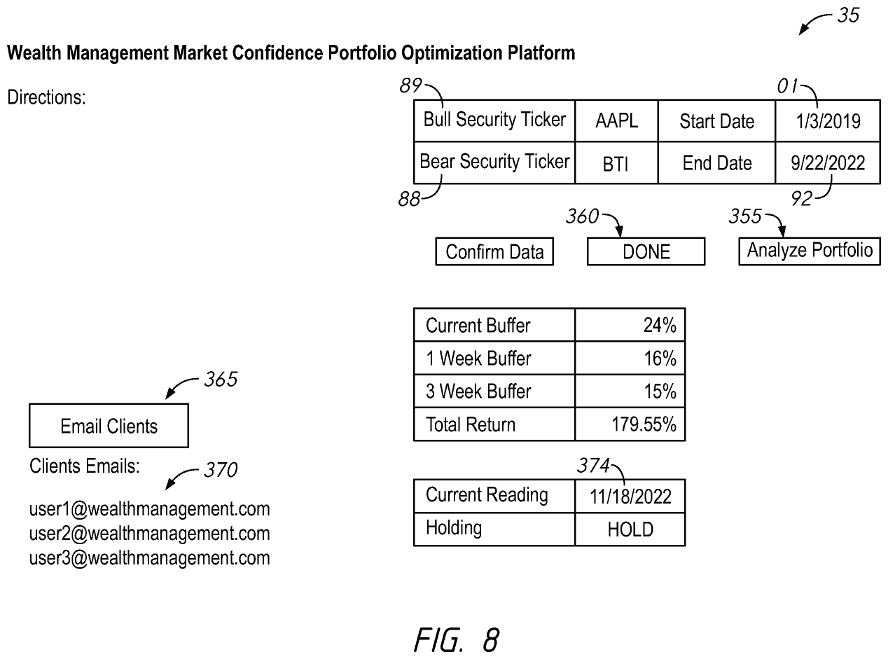

Regardless of the direction of a given recommendation 80 (i.e., whether to buy 81, sell 82 or hold 83 a given ticker), the system 5 optionally notifies 85 one or more clients of the recommendation 80 via an email or text notification sent from the system 5 and to the computer and/or smart-phone of such one or more users. As illustrated in FIG. 8, which depicts an alternative embodiment of the GUI 35, upon receiving a given recommendation 80, the user optionally executes an “Email Clients” command using the keyboard or by clicking on an “Email Clients” button 365 within the GUI. Utilizing an email listing 370 input to the GUI 35 by the user, the system thereafter emails the recommendation 80 to each user through the network interface 20.

### Second Comparison

in the second comparison 210, the processor 10 utilizes the first data drift (1^{st} DDT) percentage value 215 (i.e., the difference between the current sentiment data (CSD) percentage value 135 and the first prior sentiment data (la PSD) percentage value 140), again for comparison to the at least one buffer percentage range 190, to further analyze the data. In a preferred embodiment, the processor 10 retrieves the current sentiment data (CSD) and first prior sentiment data (1^{st} PSD) percentage values 135 and 140 from the memory 15 of the system 5, with these values preferably having been previously correlated with their associated current and first prior survey data date values 130 and 160 by the processor and stored to the memory 15 at that time. However, it is nonetheless understood that the user can again input these values 135 and 140 into the processor 10 via the keyboard 30 and/or GUI 35 (FIG. 4).

The processor 10 calculates difference between the current sentiment data (CSD) percentage value 135 and the first prior sentiment data (1^{st} PSD) percentage value 140 to determine the first data drift tolerance (1^{st} DDT) percentage value 215;

$${1}^{st} DDT \% = CSD \% - {1}^{st} PSD \% .$$

The processor 10 thereafter compares the first data drift tolerance (1^{st} DDT) percentage value 215 to the at least one percentage buffer range 190 to determine whether the first data drift tolerance (1^{st} DDT) percentage value falls outside of, or within the negative and positive endpoints 195 and 200 of at the least one buffer percentage range. Again, the first prior time duration 165 of the first data drift tolerance (1^{st} DDT) percentage 215 preferably comprises one week from the current survey data date 135 to capture-short-term shifts in Investor market confidence. However, it is understood that the first prior time duration 165 may comprise any duration of time longer or shorter than a week as well.

After calculating the first data drift tolerance (1^{st} DDT) percentage value 215 the processor 10 compares that percentage to the at least one buffer percentage range 190 to determine whether or not the first data drift tolerance (1^{st} DDT) percentage value falls outside of, or within the negative and positive endpoints 195 and 200 of at least one buffer percentage range. In a preferred embodiment, the processor 10 retrieves the at least one buffer percentage range 190 from the memory 15 of the system 5, with such percentage range having been input to the processor and stored to the memory at an earlier time. However, it is nonetheless understood that the user can again input the at least one buffer percentage range endpoint values 195 and 200 to the processor 10 via the keyboard 30 or GUI 35 (FIG. 4).

If the first data drift tolerance (1^{st} DDT) percentage value 215 falls outside the negative and positive endpoints 195 and 200 of the at least one buffer percentage range 190, the processor 10 generates the output comprising the recommendation 80 to the output device 40 (printer 50, display 45 and/or GUI 35) recommending the bearish or bullish ticker 88 or 89 to invest in. Thus, with the first data drift tolerance (1^{st} DDT) percentage value 215 falling outside the negative and positive endpoints 195 and 200 of the at least one buffer percentage range 190, the recommendation 80 will comprise a recommendation to buy the bearish ticker 88 if the first data drift tolerance (1^{st} DDT) percentage value 215 falls below (i.e., is less than) the negative endpoint of the buffer percentage range. Similarly, the recommendation 80 will comprise a recommendation to buy the bullish ticker 89 if the first data drift tolerance (1^{st} DDT) percentage value 215 falls above (i.e., is greater than) the positive endpoint 200 of the buffer percentage range 190. However, if the first data drift tolerance (1^{st} DDT) percentage value 215 falls within the at least one percentage buffer range 190 or on one of its endpoints 195 or 200, the processor preferably executes a command to proceed to the third comparison 220. In an alternate embodiment, the processor 10, without proceeding to the third comparison 220 for additional data analyses, generates output to the output device 40 (printer 50, display 45 and/or GUI 35) in the form of the recommendation 80 comprising a recommendation to “hold” 83 the ticker Instead of buying or selling it.

Regardless of the direction of a given recommendation 80 (i.e., whether to buy 81, sell 82 or hold 83 a given ticker), the system 5 optionally notifies 85 one or more clients of the recommendation 80 via an email or text notification sent from the system 5 and to the computer and/or smart-phone of such one or more users. As Illustrated in FIG. 8, which depicts an alternative embodiment of the GUI 35, upon receiving a given recommendation 80, the user optionally executes an “Email Clients” command using the keyboard or by clicking on an “Email Clients” button 365 within the GUI. Utilizing an email listing 370 input to the GUI 35 by the user, the system thereafter emails the recommendation 80 to each user through the network interface 20.

### Third Comparison

In the third comparison 220, the processor 10 utilizes the second data drift percentage 225 (i.e., the difference between the current sentiment data (CSD) percentage value 135 and 24 the second prior sentiment data (2nd PSD) percentage value 145), again for comparison to the at least one buffer percentage range 190, to further analyze the data. In a preferred embodiment, the processor 10 retrieves the current sentiment data (CSD) and second prior sentiment data (2^{nd} PSD) percentage values 135 and 145 from the memory 15 of the system 5. with these values having been previously correlated with their associated current and second prior sentiment date values 130 and 180 by the processor and stored to the memory 15 at that time. However, it is nonetheless understood that the user can again input these values to the processor 10 via the keyboard 30 or GUI 35 (FIG. 4).

The processor 10 calculates difference between the current sentiment data (CSD) percentage value 135 and the second prior sentiment data (2^{nd} PSD) percentage value 145 to determine the second data drift tolerance (2nd DDT) percentage value 225:

$${2}^{nd} DDT \% = CSD \% - {2}^{nd} PSD \% .$$

The processor 10 thereafter compares the second data drift tolerance (2^{nd} PSD) percentage value 225 to the at least one percentage buffer range 190 to determine whether the second data drift tolerance (2^{nd} DDT) percentage value falls outside of, or within the negative and positive endpoints 195 and 200 of at the least one buffer percentage range. Again, the second prior time duration 185 of the second data drift tolerance (2^{nd} PSD) percentage 225 comprises three weeks from the current survey data date 130 to smooth out irrelevant fluctuations of the return. Such fluctuations may include updates to market data releases, loss of momentum in market movements, markets whipsawing between expected data and/or earnings results and actual results, as well as those fluctuations that may occur within the aforementioned one-week periods. However, it is understood that the second prior time duration 145 may comprise any duration of time longer or shorter than three weeks, so long that it exceeds the first prior time duration 165 of the 1^{st} data drift tolerance (1^{st} DDT) percentage value 215.

After calculating the second data drift tolerance (2^{nd} DDT) percentage value 225, the processor 10 compares that percentage to the at least one buffer percentage range 190 to determine whether or not the second data drift tolerance (2^{nd} DDT) percentage value falls outside of, or within the negative and positive endpoints 195 and 200 of at least one buffer percentage range. In a preferred embodiment, the processor 10 retrieves the at least one buffer percentage range 190 from the memory 15 of the system 5, with such percentage range having been input to the processor and stored to the memory at an earlier time. However, it is nonetheless understood that the user can again input this value to the processor 10 via the keyboard 30 or GUI 35 (FIG. 4).

If the second data drift tolerance (2^{nd} DDT) percentage value 225 falls outside the negative and positive endpoints 195 and 200 of the at least one buffer percentage range 190, the processor 10 generates an output comprising the recommendation 80 to the output device (printer 50, display 45 and/or GUI 35) recommending the bearish or bullish ticker 88 or 89 to invest in. Thus, with the second data drift tolerance (2^{nd} DDT) percentage value 225 falling outside the negative and positive endpoints 195 and 200 of the at least one buffer percentage range 190, the recommendation 80 will comprise a recommendation to buy the bearish ticker 88 if the second data drift tolerance (2^{nd} DDT) percentage value 225 falls below (i.e., is less than) the negative endpoint of the buffer percentage range. Similarly, the recommendation 80 will comprise a recommendation to buy the bullish ticker 89 if the second data drift tolerance (2nd DDT) percentage value 225 falls above (i.e., is greater than) the positive endpoint 200 of the buffer percentage range 190. However, if the second data drift tolerance (2nd DDT) percentage value 225 falls within the at least one percentage buffer range 290 or on one of Its endpoints 195 or 200 processor 10 preferably generates output to the output device 40 (i.e., the printer 50, display 45 and/or GUI 35) in the form of the recommendation 80 comprising a recommendation to “hold” 83 the ticker Instead of buying or selling it.

Regardless of the direction of a given recommendation 80 (i.e., whether to buy 81, sell 82 or hold 83 a given ticker), the system 5 optionally notifies 85 one or more clients of the recommendation 80 via an email or text notification sent from the system 5 and to the computer and/or smart-phone of such one or more users. As illustrated in FIG. 8, which depicts an alternative embodiment of the GUI 35, upon receiving a given recommendation 80, the user optionally executes an “Email Clients” command using the keyboard or by clicking on an “Email Clients” button 365 within the GUI. Utilizing an email listing 370 input to the GUI 35 by the user, the system thereafter emails the recommendation 80 to each user through the network interface 20.

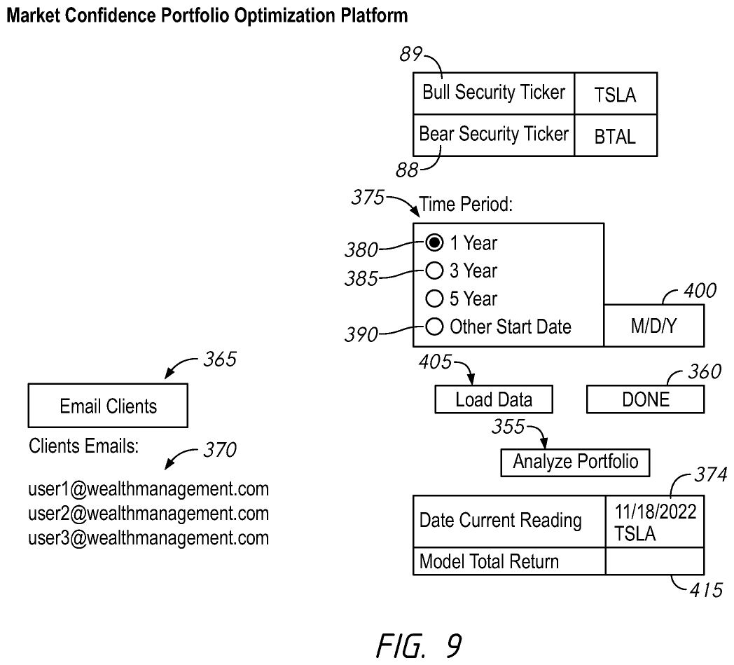

in a further embodiment of the system 5 illustrated within the GUI 35 of FIG. 9, the processor 10 generates optional time-specific data reports specified by the user. These time-specific reports are designated by one or more time periods (i.e., durations) beginning on a past date and ending on the current date 374. For example, within the “Time Period” selection field 375 of FIG. 9, the user may select: a “1 Year” 380 time period beginning one year in the past from the present date; a “5 Year” 385 time period beginning three years in the past from the present date; a “S Year” 390 time period beginning 5 years in the past from the present date; or designate a custom time period by designating an “Other Start Date” 395 in the past from the present date. When selecting the “Other Start Date” 390 within the GUI 35, the user enters that date into the “Other Start Date” entry field 395 of the GUI.

After the user selects a given time period, the “Load Data” button 405 within the GUI 35 is actuated, upon which the GUI indicates “Done” 360 after the return data for a given time period is loaded to the processor 10 from the memory 15. When the “Done” indicator appears, the user actuates the “Analyze Portfolio” button 355 within the GUI 35. The processor 10 thereafter compiles the return data for the given time period and sends the compiled return data to the output device 40. The processor 10 also presents the recommended ticker for that time period within the “Current reading” indicator 410 field of the GUI, along with the “Model Total Return” percentage value 415 (i.e., the total net return percentage value occurring since the start date) compiled by the processor. The report(s) may also optionally be emailed 365 to the client(s) 370, as previously discussed.

### METHOD

### Input Stock Tickers and Date Range

In a method 6 of using the system 5 of FIG. 6, a user monitors securities information provided by a securities information provider 60, or utilizes the system 5 to monitor the information through the network interface 20. Utilizing this information, the user selects and inputs at least one stock ticker 86 into the processor 10 of the system 5. In a preferred embodiment, the user selects and inputs the at least one ticker comprising a pair of current stock tickers 88 and 89 of respective bearish (i.e., performing well in a down market) and bullish (i.e. rising) performance.

In one embodiment, the user selects and inputs the tickers 88 and 89 of the pair to the processor 10 using the keyboard 30 and/or GUI 35 input devices. For example, within the GUI illustrated in FIG. 7, the user manually enters the ticker values 88 and 89 of the pair into the ticker holding places 325 and 330 of the GUI 35. In another embodiment, the user utilizes the processor 10 of the system 5 to automatically select and receive the ticker values 88 and 89 via Information received through the network interface 20 from a securities information provider 60, based upon selection parameters previously defined by the user. Although the user preferably utilizes negative (bearish) and high (bullish) beta stock tickers 88 and 89, it is understood that the user may utilize tickers comprising any tradable investment security, to include bonds, commodities, and/or ETF's, ETN's and mutual funds comprising one or more of these security type.

The user also inputs a trading-time date range 87, defined by trading-time beginning and ending endpoints (i.e., start and end dates)91 and 92, into the processor 10 through the keyboard 30 and/or date range holding places 335 and 340 of the GUI 35. The trading-time beginning and ending endpoints (i.e., start and end dates) 91 and 92 preferably comprise a start date falling on a Thursday and an end date falling on a subsequent Wednesday, preferably at the close of the market, to define a one-week time duration. The one-week time duration of the trading-time date range 87 is preferred because it conforms to a one-week duration of the sentiment survey data date range (to be further discussed).

It is understood, however, that any time duration of the trading-time date range 87 may be defined by the entered beginning and ending endpoints (i.e., start and end dates) 91 and 92, to include durations exceeding, or shorter than, a week. Although the user preferably inputs the date range values 91 and 92 of the trading-time date range 87 into the processor 10 via the keyboard 30 and/or holding places 335 and 340 of GUI 35 (FIG. 4), other embodiments of the method 6 comprise the user utilizing the processor 10 to automatically select and receive the date range values via information received through the network Interface 20, based upon calendar parameters previously defined by the user.

Confirm input Tickers and Date Range

Upon the processor 10 receiving the ticker pair and trading-time date range endpoint values 88 and 89, 91 and 92, respectively, the user utilizes the processor to confirm the data by executing a “confirm data” command using the keyboard or clicking on a “Confirm Data” button 345 within the GUI 35 (FIG. 4). The user thus utilizes the processor 10 to verify the credibility and trading time of the received ticker values 88 and 89 using securities information received by the processor through the network interface 20 from the securities information provider 60. In verifying the ticker values 88 and 89, the user utilizes the processor 10 to confirm that the stocks underlying the positive (bullish) and negative (bearish) beta values are indeed actively trading, and that the trading duration of each of the stocks occurs for the time duration defined by the trading-time date range 87.

If the stocks are not actively trading (i.e., a stock is “de-listed” from a given market), and/or not trading for the duration defined by the trading-time date range values 91 and 92, the user receives an error message 350 generated by the processor 10 and indicated by the output device 40 (i.e., by the printer 50, display 45 and/or the GUI 35) or the GUI 35 input device 25. If indicated by the GUI 35 input device 10, the GUI highlights or indicates an “Error” message 350 (FIG. 7). The user thereafter adjusts the ticker and date range values 88 and 89, 91 and 92 using the input device (i.e., the keyboard 30 and/or the ticker and date range holding places 325 and 330, 335 and 340 of the GUI 35), and again utilizes the processor 10 to confirm the data by executing a “confirm data” command using the keyboard or the “Confirm Data” button 345 within the GUI 35 (FIG. 4). If the stocks are actively trading, and for the duration defined by the trading-time date range values 91 and 92, then the user is allowed, by the processor 10 to proceed to the first comparison 205.

In support of the first comparison 205 illustrated within FIG. 6, the user receives, with the computer processor 10, a pair of current sentiment survey data percentage values 120 and 125 provided by the third party securities information provider 60, preferably by The American Association of Individual investors (the AAII). The user preferably monitors these values 120 and 125, again preferably comprising the current % Bearish value and current % Bullish value survey results for the survey data date range 115 defined by beginning and ending endpoints 116 and 117 for the current week (the ending endpoint denoted by the survey data date value 130), or utilizes the processor 10 to monitor them through the network interface 20. In one embodiment, the user inputs the current % Bearish and Bullish survey values 120 and 125, and the current survey data date value 130, via an input through the input device 25 comprising the keyboard 30 and/or GUI 35. In another embodiment, the user utilizes the processor 10 to receive the values through the network interface 20 directly from the securities information provider 60.

Having received the foregoing current % Bearish and Bullish survey values 120 and 125, and current survey data date value 130, the user utilizes the processor 10 to determine a current sentiment data (CSD) percentage value 135 by calculating a difference between the absolute values of the respective % Bullish and % Bearish survey values 120 and 125:

$$CSD \% = abs ( current \% Bullish survey value ) - abs ( current \% Bearish survey value ) .$$

The user preferably thereafter utilizes the processor 10 to save the current sentiment data (CSD) percentage value 125 to the memory 15, preferably for later retrieval during one or more companion processes 205, 210 and/or 220.

### First Comparison

To ensure an accurate correlation with historic S & P 500 returns, the user inputs at least one buffer percentage range 190 into the processor 10 through the keyboard or GUI 35, with the at least one buffer percentage range comprising the negative and positive equivalent endpoints 195 and 200 about a zero value. After the at least one buffer percentage range 190 is input into the processor 10, the user utilizes the processor 10 to compare the current sentiment data (CSD) percentage value 135 to the at least one buffer percentage range 190 to determine whether or not the current sentiment data (CSD) percentage value falls outside of, or within the negative and positive endpoints 195 and 200 of at the least one buffer percentage range. If the current sentiment data (CSD) percentage value 135 falls outside the negative and positive endpoints 195 and 200 of the at least one buffer percentage range 190, the user receives output, generated to the output device 40 (printer 50, display 45 and/or GUI 3S) from the processor 10, comprising the recommendation 80 recommending the bearish or bullish ticker 88 or 89 of the pair to invest in.

Thus, with the current sentiment data (CSD) percentage value 135 falling outside the negative and positive endpoints 195 and 200 of the at least one buffer percentage range 190, the recommendation 80 received by the user will comprise a recommendation to buy the bearish ticker 88 if the current sentiment data (CSD) percentage value falls below (i.e., is less than) the negative endpoint of the buffer percentage range. Similarly, the recommendation 80 received by the user will comprise a recommendation to buy the bullish ticker 89 if the current 1B sentiment data (CSD) percentage value 135 falls above (i.e., is greater than) the positive endpoint 200 of the buffer percentage range 190. However, if the current sentiment data (CSD) percentage value 135 falls within the at least one percentage buffer range 190 or on one of its endpoints 195 or 200, the user is allowed by the processor 10 to proceed to the second comparison 210. In an alternate embodiment, the user is allowed by the processor 10, without proceeding to the second comparison 210 for additional data analyses, to receive output from the output device 40 (printer 50, display 4S and/or GUI 35) in the form of the recommendation 80 comprising a recommendation to “hold” 83 the ticker instead of buying or selling it.

Regardless of the direction of a given recommendation 80 (i.e., whether to buy 81, sell 82 or hold 83 a given ticker), received by the user, the user is optionally allowed to notify 85 one or more clients of the recommendation 80 via an email or text notification sent by the user via the system 5 and to the computer and/or smart-phone of such one or more users. As illustrated in FIG. 8, which depicts an alternative embodiment of the GUI 35, upon receiving a given recommendation 80, the user optionally executes an “email clients” command using the keyboard or by clicking on a “Email Clients” button 365 within the GUI. Utilizing an email listing 370 input to the GUI 35 by the user, the system thereafter emails the recommendation 80 to each user through the network interface 20.

### Second Comparison

In the second comparison 210, the user, by the processor 10, utilizes the first data drift (1^{st} DDT) percentage value 215 (i.e., the difference between the current sentiment data (CSD) percentage value 135 and the first prior sentiment data (1^{st} DDT) percentage value 140), again for comparison to the at least one buffer percentage range 190, to further analyze the data. In a preferred embodiment, the user, utilizing the processor 10, retrieves the current sentiment data (CSD) and first prior sentiment data (1^{st} DDT) percentage values 135 and 140 from the memory 15 of the system 5, with the user preferably having previously utilized the processor to correlate these values with their associated current and first prior date survey data date values 130 and 160; the user having utilized the processor to store the values to the memory 15 at an earlier time. However, it is nonetheless understood that the user can again input these percentage values 135 and 140 to the processor 10 via the keyboard 30 and/or GUI 35 (FIG. 4).

The user utilizes the processor 10 to calculate a difference between the current sentiment data (CSD) percentage value 135 and the first prior sentiment data (1^{st} DDT) percentage value 140 to determine the first data drift tolerance (1^{st} DDT) percentage value 215:

$${1}^{st} DDT \% = CSD \% - {1}^{st} PSD \% .$$

S The user, by the processor 10, thereafter compares the first data drift tolerance (1^{st} DDT) percentage value 21 to the at least one percentage buffer range 190 to determine whether the first data drift tolerance (1^{st} DDT) percentage value falls outside of, or within the negative and positive endpoints 195 and 200 of at the least one buffer percentage range. Again, the first prior time duration 165 of the first data drift tolerance (1^{st} DDT) percentage 215 preferably comprises one week from the current survey data date 130 to capture-short-term shifts in investor market confidence. However, it is understood that the first prior time duration 165 may comprise any duration of time longer or shorter than a week as well.

After utilizing the processor 10 to calculate the first data drift tolerance (1^{st} DDT) percentage value 215, the user utilizes the processor to compare that percentage to the at least one buffer percentage range 190 to determine whether or not the first data drift tolerance (1^{st} DDT) percentage value fails outside of, or within the negative and positive endpoints 195 and 200 of at least one buffer percentage range, in a preferred embodiment, the user utilizes the processor 10 to retrieve the at least one buffer percentage range 190 from the memory 15 of the system 5, with such percentage range having been input to the processor and stored to the memory at an earlier time. However, it is nonetheless understood that the user can again input the at least one buffer percentage range endpoint values 195 and 200 to the processor 10 via the keyboard 30 or GUI 35 (FIG. 4).

If the first data drift tolerance (1^{st} DDT) percentage value 215 falls outside the negative and positive endpoints 195 and 200 of the at least one buffer percentage range 190, the user receives an output comprising the recommendation 80 generated by the processor 10 to the output device 40 (printer 50, display 45 and/or GUI 35) recommending the bearish or bullish 3 ticker 88 or 89 to invest in. Thus, with the first data drift tolerance (1^{st} DDT) percentage value 215 falling outside the negative and positive endpoints 195 and 200 of the at least one buffer percentage range 190, the recommendation 80 received by the user will comprise a recommendation to buy the bearish ticker 88 if the first data drift tolerance (1^{st} DDT) percentage value 215 falls below (i.e., is less than) the negative endpoint of the buffer percentage range. Similarly, the recommendation 80 received by the user will comprise a recommendation to buy the bullish ticker 89 if the first data drift tolerance (1^{st} DDT) percentage value 215 falls above (i.e., is greater than) the positive endpoint 200 of the buffer percentage range 190. However, if the first data drift tolerance (1^{st} DDT) percentage value 215 falls within the at least one percentage buffer range 190 or on one of its endpoints 195 or 200, the user is allowed by the processor 10 to proceed to the third comparison 220. In an alternate embodiment, the user as allowed by the processor 10, without proceeding to the third comparison 220 for additional data analyses, to receive output from the output device 40 (printer 50, display 45 and/or GUI 35) in the form of the recommendation 80 comprising a recommendation to “hold” 83 the ticker instead of buying or selling it.

Regardless of the direction of a given recommendation 80 (i.e., whether to buy 81, sell 82 or hold 83 a given ticker), received by the user, the user is optionally allowed to notify 85 one or more clients of the recommendation 80 via an email or text notification sent by the user via the system 5 and to the computer and/or smart-phone of such one or more users. As illustrated in FIG. 8, which depicts an alternative embodiment of the GUI 35, upon receiving a given recommendation 80, the user optionally executes an “email clients” command using the keyboard or by clicking on a “Email Clients” button 365 within the GUI. Utilizing an email listing 370 input to the GUI 35 by the user, the system thereafter emails the recommendation 80 to each user through the network interface 20.

### Third Comparison

In the third comparison 220, the user, by the processor 10, utilizes the second data drift percentage 225 (i.e., the difference between the current sentiment data (CSD) percentage value 135 and the second prior sentiment data (2nd PSD) percentage value 145), again for comparison to the at least one buffer percentage range 190, to further analyze the data. In a preferred embodiment, the user, utilizing the processor 10, retrieves the current sentiment data (CSD) and second prior sentiment data (2^{nd} PSD) percentage values 135 and 145 from the memory 15 of the system 5, with the user preferably having previously utilized the processor to correlate these values with their associated current and second prior survey data date values 115 and 180; the user having utilized the processor to store the values to the memory 1S at an earlier time. However, it is nonetheless understood that the user can again input the percentage values 135 and 145 to the processor 10 via the keyboard 30 or GUI 35 (FIG. 4).

The user utilizes the processor 10 to calculate a difference between the current sentiment data (CSD) percentage value 135 and the second prior sentiment data (2^{nd} PSD) percentage value 145 to determine the second data drift tolerance (2nd DDT) percentage value 225:

$${2}^{nd} DDT \% = CSD \% - {2}^{nd} PSD \% .$$

The user, by the processor 10, thereafter compare the second data drift tolerance (2^{nd} DDT) percentage value 225 to the at least one percentage buffer range 190 to determine whether the second data drift tolerance (2^{nd} DDT) percentage value tails outside of, or within the negative and positive endpoints 195 and 200 of at the least one buffer percentage range. Again, the second prior time duration 185 of the second data drift tolerance (2^{nd} DDT) percentage 22S comprises three weeks from the current survey data date 130 to smooth out irrelevant fluctuations of the return. Such fluctuations may include updates to market data releases, loss of momentum in market movements, markets whipsawing between expected data and/or earnings results and actual results, as well as those fluctuations that may occur within the aforementioned one-week periods. However, it is understood that the second prior time duration 185 may comprise any duration of time longer or shorter than three weeks, so long that it exceeds the first prior time duration 165 of the 1^{st} data drift tolerance (1^{st} DDT) percentage value 215.

After utilizing the processor 10 to calculate the second data drift tolerance (2^{nd} DDT) percentage value 225, the user utilizes the processor 10 to compare that percentage to the at least one buffer percentage range 190 to determine whether or not the second data drift tolerance (2^{nd} DDT) percentage value falls outside of, or within the negative and positive endpoints 195 and 200 of at least one buffer percentage range. In a preferred embodiment, the user utilizes the processor 10 to retrieve the at least one buffer percentage range 190 from the memory 15 of the system 5, with such percentage range having been input to the processor and stored to the memory 1S at an earlier time. However, it is nonetheless understood that the user can again input the negative and positive endpoint values 195 and 200 of the range to the processor 10 via the keyboard 30 or GUI 35 (FIG. 4).

If the second data drift tolerance (2^{nd} DDT) percentage value 225 falls outside the negative and positive endpoints 195 and 200 of the at least one buffer percentage range 190, the user receives an output comprising the recommendation 80 generated by the processor 10 to the output device 40 (printer 50, display 45 and/or GUI 35) recommending the bearish or bullish ticker 88 or 89 to invest in. Thus, with the second data drift tolerance (2^{nd} DDT) percentage value 225 falling outside the negative and positive endpoints 195 and 200 of the at least one buffer percentage range 190, the recommendation 80 received by the user will comprise a recommendation to buy the bearish ticker 89 if the second data drift tolerance (2^{nd} DDT) percentage value 225 falls below (i.e., is less than) the negative endpoint of the buffer percentage range. Similarly, the recommendation 80 received by the user will comprise a recommendation to buy the bullish ticker 89 if the second data drift tolerance (2nd DDT) percentage value 22S falls above (i.e., is greater than) the positive endpoint 200 of the buffer percentage range 190. However, if the second data drift tolerance (2nd DDT) percentage value 225 falls within the at least one percentage buffer range 190 or on one of its endpoints 195 or 200, the user receives an output generated by the processor 10 to the output device 40 (i.e., the printer 50, display 45 and/or GUI 35) in the form of the recommendation 80 comprising a recommendation to “hold” 83 the ticker Instead of buying or selling it.

Regardless of the direction of a given recommendation 80 (i.e., whether to buy 81, sell 82 or hold 83 a given ticker), received by the user, the user is optionally allowed to notify 85 one or more clients of the recommendation 80 via an email or text notification sent by the user via the system 5 and to the computer and/or smart-phone of such one or more users. As illustrated in FIG. 8, which depicts an alternative embodiment of the GUI 35, upon receiving a given recommendation 80, the user optionally executes an “Email Clients” command using the keyboard or by clicking on a “Email Clients” button 365 within the GUI. Utilizing an email listing 370 input to the GUI 35 by the user, the system thereafter emails the recommendation 80 to each user through the network interface 20.

In a further embodiment of the system 5 illustrated within the GUI 35 of FIG. 9, the user, by the processor 10, generates optional time-specific data reports specified by the user. These time-specific reports are designated by one or more time periods (i.e., durations) selected by the user and beginning on a past date and ending on the current date 374. For example, within the “Time Period” selection field 375 of FIG. 9, the user may select: a “1 Year” 380 time period beginning one year in the past from the present date; a “3 Year” 385 time period beginning three years in the past from the present date; a “5 Year” 390 time period beginning 5 years in the past from the present date; or designate a custom time period by designating an “Other Start Date” 395 in the past from the present date. When selecting the “Other Start Date” 390 within the GUI 35, the user enters that date into the “Other Start Date” entry field 395 of the GUI.

After the user selects a given time period, the “Load Data” button 405 within the GUI 35 is actuated, upon which the GUI indicates “Done” 360 after the return data for a given time period is loaded to the processor 10 from the memory 15. When the “Done” indicator appears, the user actuates the “Analyze Portfolio” button 355 within the GUI 35. The processor 10 thereafter compiles the return data for the given time period and sends the compiled return data to the output device 40. The processor 10 also presents the recommended ticker for that time period within the “Current reading” Indicator 410 field of the GUI, along with the “Model Total Return” percentage value 415 (i.e., the total net return percentage value occurring since the start date) compiled by the processor. The report(s), by the processor 10, may also optionally be emailed 365 to the client(s) 370, as previously discussed.

### Article of Manufacture (Software)

In yet another embodiment, a non-transitory computer-readable medium having instructions to control one or more processors is utilized, with the computer-readable medium comprising processor-executable instructions configured to instruct one or more embodiments of the aforementioned system 5 to carry out the aforementioned method 6. The media upon which the instructions are encoded comprise CDs, CDs, DVDs, flash drives, hard disk drives and other similar media understood in the art. The instructions, typically comprising binary data understood in the art, are configured to operate according to one or more of the principles set forth herein.

### Input Stock Tickers and Date Range

In one embodiment, the computer readable medium comprises instructions configured to direct a processor 10 of the system 5 to allow a user to monitor securities information provided by a securities information provider 60, or to monitor the information through the network interface 20. The instructions are further configured to direct the processor 10 to receive at least one stock ticker 86 selected by the user and input into the processor 10 of the system 5. In a preferred embodiment, the at least one ticker 86 comprises a pair of stock tickers 88 and 89 of respective bearish (i.e. performing well in a down market) and bullish (i.e., performing well in an up market) performance.

In one embodiment, the tickers 88 and 89 of the pair received by the processor 10 are input using the keyboard 30 and/or GUI 35 input devices. For example, the instructions are configured to direct the processor to receive the ticker values 88 and 89 of the pair entered into the ticker holding places 325 and 335 of the GUI 35 of FIG. 4. In another embodiment, the instructions are configured to direct the processor 10 of the system 5 to automatically select and receive the ticker values 88 and 89 via information received through the network interface from a securities information provider 60, based upon selection parameters previously defined by the user. Although the instructions direct the processor 10 to preferably receive negative (bearish) and high (bullish) beta stock tickers 88 and 89, it is understood that the instructions may direct the processor to receive tickers comprising any tradable investment security, to Include bonds, commodities, and/or ETF's. ETN's and mutual funds comprising one or more of these security types.

The Instructions are further configured to direct the processor 10 to receive a trading-time date range 87, defined by trading-time beginning and ending endpoint (i.e., start and end dates)91 and 92, input into the processor 10 by a user through the keyboard 30 and/or date range holding places 335 and 340 of the GUI 35. The trading-time beginning and ending endpoint (i.e., start and end dates) 91 and 92 preferably comprise a start date falling on a Thursday and an end date falling on a subsequent Wednesday, preferably at the close of the market, to define a one-week time duration. The one-week time duration of the trading-time date range 87 is preferred because it conforms to a one-week duration of the sentiment survey data date range (to be further discussed). It is understood, however, that any time duration of the trading-time date range 87 may be defined by the entered beginning and ending endpoints (i.e., start and end dates) 91 and 92, to include durations exceeding, or shorter than, a week. Although the instructions are configured to direct the processor 10 to receive an input of the date range endpoint values 91 and 91 of the trading-time date range 87 via the keyboard 30 and/or holding places 335 and 340 of GUI 35 (FIG. 4), other embodiments of the article 7 comprise the instructions configured to direct the processor 10 to automatically select and receive the date range endpoint values 91 and 92 via information received through the network Interface 20, based upon calendar parameters previously defined by the user.

### Confirm Input Tickers and Date Range

After the processor 10 receives the ticker pair and trading-time date range values 88 and 89, 91 and 92, respectively, the instructions direct the processor to confirm the data upon the execution of a “confirm data” command by the user through the keyboard or through an actuation by the user of a “Confirm Data” button 345 within the GUI 35 (FIG. 4). The Instructions thus direct the processor 10 to verify the credibility and trading time of the received ticker values 88 and 89 using securities information received by the processor through the network interface 20 from the securities information provider 60. In verifying the ticker values 88 and 89, the processor confirms that the stocks underlying the negative (bearish) and positive (bullish) beta values are indeed actively trading, and that the trading duration of each of the stocks occurs for the time duration defined by the trading-time date range 87.

The instructions are further configured to direct the processor to, if the stocks are not actively trading (i.e., a stock is “de-listed” from a given market) and/or not trading for the duration defined by the trading-time date range endpoint values 91 and 92, generate an error message for indication by the output device 40 (i.e., by the printer 50, display 45 and/or the GUI 35) or by the GUI 35 input device 25. If indicated by the GUI 35 input device 10, the instructions direct the GUI to highlight or indicate an “Error” message 350 (FIG. 7) and are configured to allow the user to thereafter adjust the ticker and date range values 88 and 89, 91 and 92 for receipt by the processor though the input device 40 (i.e., the keyboard 30 and/or the ticker and date range holding places 325 and 330, 335 and 340 of the GUI 35), with the instructions directing the processor 10 to again confirm the data via an execution of a “confirm data” command by the user using the keyboard or the “Confirm Data” button 345 within the GUI 35 (FIG. 4). The instructions further direct the processor 10, if the stocks are actively trading, and for the duration defined by the trading-time date range endpoint values 91 and 92, to proceed to the first comparison 205.

In support of the first comparison 205 illustrated within FIG. 6, the instructions are configured to direct the processor 10 to receive a pair of current sentiment survey data percentage values 120 and 125 provided by the third party securities information provider 60; preferably by The American Association of Individual investors (the AAII). The instructions direct the processor 10 to allow the user to monitor these percentage values 120 and 125, again preferably comprising the current % Bearish value and current % Bullish value survey results for the survey data date range 115 (i.e., current week) defined by the endpoints 116 and 117 (the ending endpoint denoted by the current survey data date value 130), or to monitor them through the network interface 20. In one embodiment, the Instructions direct the processor to receive the current % Bearish and Bullish survey values 120 and 125, and the current survey data date value 130, via an input by the user through the input device 40 comprising the keyboard 30 and/or GUI 35. In another embodiment, the instructions direct the processor 10 to receive the values through the network interface 20 directly from the securities information provider 60.

Having received the foregoing current % Bearish and Bullish survey values 120 and 125, and current survey data date value 130, the instructions direct the processor 10 to determine a current sentiment data (CSD) percentage value 135 by calculating a difference between the absolute values of the respective % Bullish and % Bearish survey values 120 and 125:

$$CSD \% = abs ( current \% Bullish survey value ) - abs ( current \% Bearish survey value ) .$$

The instructions further direct the processor 10 to save the current sentiment data (CSD) percentage value ## to the memory 15, preferably for later recall during one or more comparison processes 205, 210 and/or 220.

### First Comparison

To ensure an accurate correlation with historic S & P 500 returns, the instructions are configured to instruct the processor 10 to receive an input by the user of at least one buffer percentage range 190 through the keyboard 30 or GUI 35, with the at least one buffer percentage range comprising negative and positive equivalent endpoints 195 and 200 about a zero value. The Instructions further direct the processor 10, after the at least one buffer percentage range 190 is received, to compare the current sentiment data (CSD) percentage value 135 to the at least one buffer percentage range 190 to determine whether or not the current sentiment data (CSD) percentage value falls outside of, or within the negative and positive endpoints 195 and 200 of at the least one buffer percentage range. The instructions further direct the processor, if the current sentiment data (CSD) percentage value 13S falls outside the negative and positive endpoints 195 and 200 of the at least one buffer percentage range 190, to generate output to the output device 40 (printer 50, display 45 and/or GUI 3S), with the output comprising a recommendation 80 recommending the bearish or bullish ticker 88 or 89 of the pair for the user to invest in.

Thus, with the current sentiment data (CSD) percentage value 135 falling outside the negative and positive endpoints 195 and 200 of the at least one buffer percentage range 190, the recommendation 80 received by the user will comprise a recommendation to buy the current bearish ticker 88 if the current sentiment data (CSD) percentage value falls below (i.e., is less than) the negative endpoint of the buffer percentage range. Similarly, the recommendation 80 received by the user will comprise a recommendation to buy the current bullish ticker 89 if the current sentiment data (CD) percentage value 135 falls above (i.e., is greater than) the positive endpoint 200 of the buffer percentage range 190. However, the instructions are configured to direct the processor to, if the current sentiment data (CSD) percentage value 135 falls within the at least one percentage buffer range 190 or on one of Its endpoints 195 or 200, allow the user to proceed to the second comparison 210, in an alternate embodiment, the Instructions are configured to direct the processor 10, without proceeding to the second comparison 210 for additional data analyses, to generate output to the output device 40 (printer 50, display 45 and/or GUI 35) in the form of the recommendation 80 comprising a recommendation to “hold” 83 the ticker instead of buying or selling it.

Regardless of the direction of a given recommendation 80 (i.e., whether to buy 81, sell 82 or hold 83 a given ticker), the instructions are configured to direct the system 5 to optionally notify S one or more clients of the recommendation 80 via an email or text notification sent from the system 5 and to the computer and/or smart-phone of such one or more users. As illustrated in FIG. 8, which depicts an alternative embodiment of the GUI 35, the Instructions direct the processor 10 such that, upon indicating a given recommendation 80, the processor receives an optionally executed “email clients” command from the keyboard or GUI; the instructions configured to allow a user to click on a “Email Clients” button 365 within the GUI. The instructions are further configured to allow the input of an email listing 370 input to the GUI 35 by the user, thereafter directing the processor to thereafter email the recommendation 80 to each user through the network Interface 20.

### Second Comparison

In the second comparison 210, the Instructions are configured to direct the processor 10 to utilize a first data drift (1^{st} DDT) percentage value 215 (i.e., the difference between the current sentiment data (CSD) percentage value 135 and the first prior sentiment data (1^{st} PSD) percentage value 140), again for comparison to the at least one buffer percentage range 190, to further analyze the data, in a preferred embodiment, the Instructions direct the processor 10 to retrieves the current sentiment data (CSD) and first prior sentiment data (1^{st} PSD) percentage values 135 and 140 from the memory 15 of the system 5, with the instructions having previously directed the processor to correlate these values with their associated current and first prior survey data date values 130 and 160; the Instructions having further directed the processor to store the values to the memory 15 at an earlier time. However, it Is nonetheless understood that Instructions can direct the processor to receive the percentage values 135 and 140 input by the user into the processor 10 via the keyboard 30 and/or GUI 35 (FIG. 4).

The instructions direct the processor 3D to calculate a difference between the current sentiment data (CSD) percentage value 135 and the first prior sentiment data (1^{st} PSD) percentage value 140 to determine the first data drift tolerance (1^{st} PSD) percentage value 215:

$${1}^{st} DDT \% = CSD \% - {1}^{st} PSD \% .$$

The instructions also further direct the processor 10 to thereafter compare the first data drift tolerance (1^{st} PSD) percentage value 215 to the at least one percentage buffer range 190 to determine whether the first data drift tolerance (1^{st} PSD) percentage value falls outside of, or within the negative and positive endpoints 195 and 200 of at the least one buffer percentage range. Again, the first prior time duration 165 of the first data drift tolerance (1^{st} DDT) percentage 215 preferably comprises one week from the current survey data date 130 to capture-short-term shifts in investor market confidence. However, it is understood that the first prior time duration 165 may comprise any duration of time longer or shorter than a week as well.

In a preferred embodiment, the instructions direct the processor 10 to retrieve the at least one buffer percentage range 190 from the memory 15 of the system 5, with the instructions having previously directed the processor to store the input percentage range to the memory at an earlier time. However, it is nonetheless understood that the instructions can direct the processor 10 to receive the inputted at least one buffer percentage range endpoint values 195 and 200 to the processor 10 via the keyboard 30 or GUI 35 (FIG. 4).

The instructions are further configured to direct the processor 10, if the first data drift tolerance (1^{st} DDT) percentage value 215 falls outside the negative and positive endpoints 195 and 200 of the at least one buffer percentage range 190, to generate an output comprising the recommendation 80 to the output device 40 (printer 50, display 45 and/or GUI 35) recommending the bearish or bullish ticker 88 or 89 for the user to invest in. Thus, with the first data drift tolerance (t DDT) percentage value 215 falling outside the negative and positive endpoints 195 and 200 of the at least one buffer percentage range 190, the recommendation 80 received by the user will comprise a recommendation to buy the bearish ticker 88 if the first data drift tolerance (1^{st} PSD) percentage value falls below (i.e., is less than) the negative endpoint of the buffer percentage range. Similarly, the recommendation 80 received by the user will comprise a recommendation to buy the bullish ticker 89 if the first data drift tolerance (1^{st} PSD) percentage value 215 falls above (i.e., is greater than) the positive endpoint 200 of the buffer percentage range 190. However, the instructions direct the processor, if the first data drift tolerance (1^{st} PSD) percentage value 215 falls within the at least one percentage buffer range 190 or on one of its endpoints 195 or 200, to allow the user to proceed to the third comparison 220, in an alternate embodiment, the instructions are configured to direct the processor 10, without proceeding to the third comparison 220 for additional data analyses, to generate output to the output device 40 (printer 50, display 45 and/or GUI 35) in the form of the recommendation 80 comprising a recommendation to “hold” 83 the ticker instead of buying or selling it.

Regardless of the direction of a given recommendation 80 (i.e., whether to buy 81, sell 82 or hold 83 a given ticker), the instructions are configured to direct the system 5 to optionally notify 6S one or more clients of the recommendation 80 via an email or text notification sent from the system 5 and to the computer and/or smart-phone of such one or more users. As illustrated in FIG. 8, which depicts an alternative embodiment of the GUI 35, the Instructions direct the processor 10 such that, upon indicating a given recommendation 80, the processor receives an optionally executed “email clients” command from the keyboard or GUI; the instructions configured to allow a user to click on a “Email Clients” button 365 within the GUI. The instructions are further configured to allow the input of an email listing 370 input to the GUI 35 by the user, thereafter directing the processor to thereafter email the recommendation 80 to each user through the network interface 20.

### Third Comparison

In the third comparison 220, the instructions are configured to direct the processor 10 to utilize the second data draft percentage 225 (i.e., the difference between the current sentiment data (CSD) percentage value 135 and the second prior sentiment data (2nd PSD) percentage value 145), again for comparison to the at least one buffer percentage range 190, to further analyze the data. In a preferred embodiment, the Instructions direct the processor 10 to retrieve the current sentiment data (CSD) and second prior sentiment data (2^{nd} PSD) percentage values 135 and 145 from the memory 15 of the system 5, with the instructions having previously directed the processor to correlate these values with their associated current and second prior survey data date values 130 and 180; the instructions having directed the processor to store the values to the memory 15 at an earlier time. However, it is nonetheless understood that the instructions can direct the processor to receive the percentage values input into the processor 10 via the keyboard 30 or GUI 35 (FIG. 4).

The instructions direct the processor 10 to calculate a difference between the current sentiment data (CSD) percentage value 135 and the second prior sentiment data (2^{nd} PSD) percentage value 145 to determine the second data drift tolerance (2nd DDT) percentage value 225:

$${2}^{nd} DDT \% = CSD \% - {2}^{nd} PSD \% .$$

The instructions further direct the processor 10 to thereafter compare the second data drift tolerance (2^{nd} DDT) percentage value 22S to the at least one percentage buffer range 190 to determine whether the second data drift tolerance (2^{nd} PSD) percentage value falls outside of, or within the negative and positive endpoints 195 and 200 of at the least one buffer percentage range. Again, the second prior time duration 185 of the second data drift tolerance (2^{nd} DDT) percentage 225 comprises three weeks from the current survey data date 160 to smooth out irrelevant fluctuations of the return. Such fluctuations may Include updates to market data releases, loss of momentum in market movements, markets whipsawing between expected data and/or earnings results and actual results, as well as those fluctuations that may occur within the aforementioned one-week periods. However, it is understood that the second prior time duration 185 may comprise any duration of rime longer or shorter than three weeks, so long that it exceeds the first prior time duration 165 of the 1^{st} data drift tolerance (1^{st} PSD) percentage value 215.

In a preferred embodiment, the instructions direct the processor 10 to retrieve the at least one buffer percentage range 190 from the memory 15 of the system 5, with the instructions having previously directed the processor to store the input percentage range to the memory 15 at an earlier time. However, it is nonetheless understood that the instructions can direct the processor 10 to receive the input of the at least one buffer range endpoint values 195 and 200 to the processor vim the keyboard 30 or GUI 35 (FIG. 4).

The instructions further direct the processor 10, if the second data drift tolerance (2^{nd} DDT) percentage value 225 falls outside the negative and positive endpoints 195 and 200 of the at least one buffer percentage range 190, to generate an output comprising the recommendation 80 to the output device 40 (printer 50, display 45 and/or GUI 35) recommending the bearish or bullish ticker 88 or 89 for the user to invest in. Thus, with the second data drift tolerance (2^{nd} DDT) percentage value 225 failing outside the negative and positive endpoints 195 and 200 of the at least one buffer percentage range 190, the recommendation 80 received by the user will comprise a recommendation to buy the bearish ticker 88 if the second data drift tolerance (2^{nd} DDT) percentage value falls below (i.e., is less than) the negative endpoint of the buffer percentage range. Similarly, the recommendation 80 received by the user will comprise a recommendation to buy the bullish ticker 89 if the second data drift tolerance (2nd DDT) percentage value 225 falls above (i.e., is greater than) the positive endpoint 200 of the buffer percentage range 190. However, the instructions direct the processor, if the second data drift tolerance (2nd DDT) percentage value 225 falls within the at least one percentage buffer range 190 or on one of its endpoints 195 or 200, to generate an output to the output device 40 (i.e, the printer 50, display 45 and/or GUI 35) in the form of the recommendation 80 comprising a recommendation to “hold” 83 the ticker instead of buying or selling it.

Regardless of the direction of a given recommendation 80 (i.e., whether to buy 81, sell 82 or hold 83 a given ticker), the instructions are configured to direct the system 5 to optionally notify 85 one or more clients of the recommendation 80 via an email or text notification sent from the system 5 and to the computer and/or smart-phone of such one or more users. As illustrated in FIG. 8, which depicts an alternative embodiment of the GUI 35, the instructions direct the processor 10 such that, upon indicating a given recommendation 80, the processor receives an optionally executed “email clients” command from the keyboard or GUI; the instructions configured to allow a user to click on a “Email Clients” button 365 within the GUI. The instructions are further configured to allow the input of an email listing 370 input to the GUI 35 by the user, thereafter directing the processor to thereafter email the recommendation 80 to each user through the network interface 20.

In a further embodiment of the system 5 illustrated within the GUI 35 of FIG. 9, the instructions configure the processor 10 to generate optional time-specific data reports specified by the user. These time-specific reports are designated by one or more time periods (i.e., durations) beginning on a past date and ending on the current date 374. For example, within the “Time Period” selection field 375 of FIG. 9, the user may select: a “1 Year” 380 time period beginning one year in the past from the present date; a “3 Year” 385 time period beginning three years in the past from the present date; a “5 Year” 390 time period beginning 5 years in the past from the present date; or designate a custom time period by designating an “Other Start Date” 395 in the past from the present date. When selecting the “Other Start Date” 390 within the GUI 35, the user enters that date into the “Other Start Date” entry field 395 of the GUI.

After the user selects a given time period, the “Load Data” button 405 within the GUI 35 is actuated, upon which the instructions configure the processor 10 to Indicate “Done” 360 within the GUI 35 after the return data for a given time period is loaded to the processor 10 from the memory 15. When the “Done” indicator appears, the user actuates the “Analyze Portfolio” button 355 within the GUI 35. The instructions configure the processor 10 to thereafter compiles the return data for the given time period and send the compiled return data to the output device 40. The instructions also configure the processor 10 to also present the recommended ticker for that time period within the “Current reading” indicator 410 field of the GUI, along with the “Model Total Return” percentage value 415 (i.e., the total net return percentage value occurring since the start date) compiled by the processor. The Instructions may also configure the processor 10 to optionally email 365 the report(s) to the client(s) 370, as previously discussed.

While this foregoing description and accompanying figures are illustrative of the present invention, other variations in structure and method are possible without departing from the invention's spirit and scope.

We claim:

1. A system for creating a securities recommendation comprising:
a processor;
a computer-readable memory, network interface, input device and output device coupled to the processor;
instructions stored on the computer-readable memory which, when executed by the processor, configure the processor to perform operations that include;
receiving, from the network Interface or input device, a trading-time date range, a current at least one ticker corresponding with the trading-time date range, a bullish sentiment survey data percentage value and a bearish sentiment survey data percentage value, the sentiment survey data percentage values having a survey date range common with the trading-time date range, and at least one buffer percentage range;
determining a current sentiment data percentage value by subtracting an absolute value of the bearish sentiment survey data percentage value from an absolute value of the bullish sentiment survey data percentage value;
comparing the current sentiment data percentage value to the at least one buffer percentage range and determining whether the current sentiment data percentage value falls within the at least one buffer percentage range or outside the at least one buffer percentage range; and
outputting the securities recommendation to the output device if the current sentiment data percentage value falls outside the at least one buffer percentage range, said securities recommendation comprising a recommendation to invest in the current at least one ticker.

2. The system of claim 1 further comprising instructions stored on the computer-readable memory which, when executed by the processor, configure the processor to perform operations that Include:
determining, if the current sentiment data percentage value falls within the at least one buffer percentage range, a first data drift tolerance value by subtracting from the current sentiment data percentage value a first prior sentiment data percentage value occurring at an earlier time by a first time duration;
comparing the first data drift tolerance value to the at least one buffer percentage range and determining whether the first data drift tolerance value falls within the at least one buffer percentage range or outside the at least one buffer percentage range; and
outputting the securities recommendation to the output device if the first data drift tolerance value falls outside the at least one buffer percentage range, said securities recommendation comprising a recommendation to invest in the current at least one ticker.

3. The system of claim 2 further comprising instructions stored on the computer-readable memory which, when executed by the processor, configure the processor to perform operations that include:
determining, if the first data drift tolerance value falls within the at least one buffer percentage range, a second data drift tolerance value by subtracting from the current sentiment data percentage value a second prior sentiment data percentage value occurring at an earlier time by a second time duration;
comparing the second data drift tolerance value to the at least one buffer percentage range and determining whether the second data drift tolerance value falls within the at least one buffer percentage range or outside the at least one buffer percentage range; and
outputting the securities recommendation to the output device if the second data drift tolerance value falls outside the at least one buffer percentage range, said securities recommendation comprising a recommendation to invest in the current at least one ticker.

4. The system of claim 3 further comprising instructions stored on the computer-readable memory which, when executed by the processor, configure the processor to perform operations that include:
outputting the securities recommendation to the output device if the second data drift tolerance value falls within the at least one buffer percentage range, said securities recommendation comprising a recommendation to hold a prior at least one ticker received by the processor at a time earlier than the current at least one ticker.

5. The system of claim 4 wherein the at least one ticker comprises a pair of tickers comprising a bullish ticker and a bearish ticker.

6. The system of claim 5 wherein the recommendation to invest in the current at least one ticker comprises a recommendation to invest in the bullish ticker if the current sentiment data percentage value, the first data drift tolerance value or the second data drift tolerance value falls above the at least one buffer percentage range, and wherein the recommendation to invest in the current at least one ticker comprises a recommendation to invest in the in the bearish ticker if the current sentiment data percentage value, the first data drift tolerance value or the second data drift tolerance value falls below the at least one buffer percentage range.

7. The system of claim 6 wherein the survey date range comprises one week, the first time duration comprises one week, and the second time duration comprises three weeks.

8. A computer implemented method for creating a securities recommendation comprising the steps of:
utilizing a computer processor coupled to a computer-readable memory, input device and output device, the memory having instructions stored thereon for execution by the processor;
receiving, by the processor, a trading-time date range, a current at least one ticker corresponding with the trading-time date range, a bullish sentiment survey data percentage value and a bearish sentiment survey data percentage value, the sentiment survey data percentage values having a survey date range common with the trading-time date range, and at least one buffer percentage range from the input device;
determining, by the processor, a current sentiment data percentage value by subtracting an absolute value of the bearish sentiment survey data percentage value from the bullish sentiment survey data percentage value;
comparing, by the processor, the current sentiment data percentage value to the at least one buffer percentage range and determining, by the processor, whether the sentiment raw difference percentage value falls within the at least one buffer percentage range or outside the at least one buffer percentage range; and
outputting, by the processor to the output device, the securities recommendation if the sentiment data percentage value falls outside the at least one buffer percentage range, said securities recommendation comprising a recommendation to invest in the current at least one ticker.

9. The method of claim 8 further comprising determining, by the processor, if the current at least current sentiment data percentage value falls within the at least one buffer percentage range, a first data drift tolerance value by subtracting from the current sentiment data percentage value a first prior sentiment data percentage value occurring at an earlier time by a first time duration;
comparing, by the processor, the first data drift tolerance value to the at least one buffer percentage range and determining, by the processor, whether the first data drift tolerance value falls within the at least one buffer percentage range or outside the at least one buffer percentage range; and
outputting, by the processor, the securities recommendation to the output device if the first data drift tolerance value falls outside the at least one buffer percentage range, said securities recommendation comprising a recommendation to invest in the current at least one ticker.

10. The method of claim 9 further comprising determining, by the processor, if first data drift tolerance value falls within the at least one buffer percentage range, a second data drift tolerance value by subtracting from the current sentiment percentage difference value a second prior sentiment data percentage value occurring at an earlier time by a second time duration;
comparing, by the processor, the second data drift tolerance value to the at least one buffer percentage range and determining, by the processor, whether the second data drift tolerance value falls within the at least one buffer percentage range or outside the at least one buffer percentage range; and
outputting, by the processor, the securities recommendation to the output device if the second data drift tolerance value falls outside the at least one buffer percentage range, said securities recommendation comprising a recommendation to invest in the current at least one ticker.

11. The method of claim 10 further comprising outputting, by the processor, the securities recommendation if the second data drift tolerance value falls within the at least one buffer percentage range, said securities recommendation comprising a recommendation to hold a prior at least one ticker received by the processor at a time earlier than the current at least one ticker.

12. The method of claim 11 wherein the at least one ticker comprises a pair of tickers having a bullish ticker and a bearish ticker.

13. The method of claim 12 wherein the recommendation to invest in the current at least one ticker comprises a recommendation to invest in the bullish ticker if the current sentiment data percentage value, the first data drift tolerance value or the second data drift tolerance value falls above the at least one buffer percentage range, and a recommendation to invest in the bearish ticker if the current sentiment data percentage value, the first data drift tolerance value or the second data drift tolerance value falls below the at least one buffer percentage range.

14. The method of claim 13 wherein the survey date range comprises one week, the first time duration comprises one week, and the second time duration comprises three weeks.

15. A computer software product that includes a non-transitory computer readable storage medium readable by a processor, the medium having stored there-on a set of instructions for creating a securities trade recommendation comprising:
a first sequence of instructions which, when executed by the processor, causes the processor to receive a trading-time date range, a current at least one ticker corresponding with the trading-time date range, a bullish sentiment survey data percentage value and a bearish sentiment survey data percentage value, the survey data percentage values having a survey date range common with the trading-time date range, and at least one buffer percentage range through a network interface or an input device;
a second sequence of instructions which, when executed by the processor, causes the processor to determine a current sentiment data percentage value by subtracting an absolute value of the bearish sentiment survey data percentage value from an absolute value of the bullish sentiment survey data percentage value;
a third sequence of instructions which, when executed by the processor, causes the processor to compare the current sentiment data percentage value to the at least one buffer percentage range and determine whether the current sentiment data percentage value falls within the at least one buffer percentage range or outside the at least one buffer percentage range; and
a fourth sequence of instructions which, when executed by the processor, causes the processor to output the securities recommendation to an output device if the current sentiment data percentage value falls outside the at least one buffer percentage range, said securities recommendation comprising a recommendation to invest in the current at least one ticker.

16. The medium of claim 15 further comprising a firth sequence of instructions which, when executed by the processor, causes the processor to determine, if the current sentiment data percentage value falls within the at least one buffer percentage range, a first data drift tolerance value by subtracting from the current sentiment data percentage value a first prior sentiment data percentage value occurring at an earlier time by a first time duration;
a sixth sequence of instructions which, when executed by the processor, causes the processor to compare the first data drift tolerance value to the at least one buffer percentage range and determine whether the first data drift tolerance value falls within the at least one buffer percentage range or outside the at least one buffer percentage range; and
a seventh sequence of instructions which, when executed by the processor, causes the processor to output the securities recommendation to the output device if the first data drift tolerance value falls outside the at least one buffer percentage range, said securities recommendation comprising a recommendation to invest in the current at least one ticker.

17. The medium of claim 16 further comprising an eighth sequence of Instructions which, when executed by the processor, causes the processor to determine, if the first data drift tolerance value falls within the at least one buffer percentage range, a second data drift tolerance value by subtracting from the current sentiment data percentage value a second prior sentiment data percentage value occurring at an earlier time by a second time duration;
a ninth sequence of instructions which, when executed by the processor, causes the processor to compare the second data drift tolerance value to the at least one buffer percentage range and determine whether the second data drift tolerance value falls within the is at least one buffer percentage range or outside the at least one buffer percentage range; and
a tenth sequence of instructions which, when executed by the processor, causes the processor to output the securities recommendation to the output device if the second data drift tolerance value falls outside the at least one buffer percentage range, said securities recommendation comprising a recommendation to invest in the current at least one ticker.

18. The medium of claim 17 further comprising an eleventh sequence of instructions which, when executed by the processor, causes the processor to output the securities recommendation to an output device if the second data drift tolerance value falls within the at least one buffer percentage range, said securities recommendation comprising a recommendation to hold a prior at least one ticker received by the processor at a time earlier than the current at least one ticker.

19. The medium of claim 18 wherein the at least one ticker comprises a pair of tickers comprising a bullish ticker and a bearish ticker.

20. The medium of claim 19 wherein the recommendation to invest in the current at least one ticker comprises a recommendation to invest in the bullish ticker if the sentiment data percentage value, the first data drift tolerance value or the second data drift tolerance value falls above the at least one buffer percentage range, and a recommendation to invest in the bearish ticker if the sentiment data percentage value, the first data drift tolerance value or the second data drift tolerance value falls below the at least one buffer percentage range.

21. The medium of claim 20 wherein the survey date range comprises one week, the first time duration comprises one week, and the second time duration comprises three weeks.
